(19) United States
(12) Patent Application Publication
(10) Pub. No.: US 2020/0090521 A1
(43) Pub. Date: Mar. 19, 2020

(54) METHOD AND APPARATUS FOR CONTROLLING A VEHICLE PERFORMING PLATOONING IN AN AUTONOMOUS DRIVING SYSTEM

(71) Applicant: LG Electronics Inc., Seoul (KR)

(72) Inventor: Cheolseung KIM, Seoul (KR)

(21) Appl. No.: 16/692,702

(22) Filed: Nov. 22, 2019

(30) Foreign Application Priority Data
Aug. 6, 2019 (KR) 10-2019-0095363

(51) Int. Cl. G08G 1/00; G05D 1/00; G05D 1/02; B60W 30/18; H04W 4/46; G08G 1/16

(52) U.S. Cl. CPC G08G 1/22; G05D 1/0088; G05D 1/0291; B60W 30/18163; H04W 4/46; G05D 2201/0213; B60W 2550/408; B60W 2550/306; B60W 2550/302; B60W 2550/20; G08G 1/163

(57) ABSTRACT

A method in which several vehicles, which perform platooning in an autonomous driving system (Autonomous Driving System), pass a target vehicle, in which the several vehicles constituting a platoon include a first vehicle controlling platooning and a second vehicle controlled by the first vehicle, and the first vehicle checks information of the platoon and determines a passing operation of the platoon on the basis of the platoon information received from the server and information about the out-platoon vehicles, thereby being able to control the vehicles performing the platooning to pass the target vehicles. One or more of an autonomous vehicle, a user terminal, and a server of the present invention may be associated with an artificial intelligence module, a drone ((Unmanned Aerial Vehicle, UAV), a robot, an AR (Augmented Reality) device, a VR (Virtual Reality) device, a device associated with 5G services, etc.

### CROSS-REFERENCE TO RELATED APPLICATIONS

This application claims priority to Korean Application No. 10-2019-0095363, filed on Aug. 6, 2019, the contents of which are incorporated by reference in their entirety.

### BACKGROUND OF THE INVENTION

### Field of the Invention

The present disclosure relates to an autonomous driving system and, more particularly, to a method of passing a vehicle by a platooning formation, and an apparatus therefore.

### Related Art

Vehicles, in accordance with the prime mover that is used, can be classified into an internal combustion engine vehicle, an external combustion engine vehicle, a gas turbine vehicle, an electric vehicle or the like.

An autonomous vehicle refers to a vehicle that can drive by it self without operation by a driver or a passenger, and an automated vehicle & highway system refers to a system that monitors and controls such an autonomous vehicle to be able to drive by itself.

When the speed of the foregoing vehicles ahead of platoon vehicles that perform platooning, which is a type of autonomous driving, is low, a problem in which the vehicles fail to arrive at a destination within a target time, so the platoon vehicles may attempt passing. In this case, when an abnormal situation such as another vehicle cutting into the platoon occurs, some of the vehicles may fail to pass and an accident may occur.

### SUMMARY OF THE INVENTION

An object of the present disclosure is to solve the necessities and/or problems described above.

An object of the present disclosure is to propose a method of safely passing a foregoing vehicle ahead of a platoon when vehicles perform platooning in an autonomous driving system, and an apparatus therefor.

Further, an object of the present disclosure is to propose a method of performing passing by deforming the shape of a platoon by reflecting a road operation situation, and an apparatus therefor.

Further, an object of the present disclosure is to propose a method of forming a new shape of platoon with vehicles that have succeeded in passing so that they arrive at a destination within a target time.

The technical subjects to implement in the present disclosure are not limited to the technical problems described above and other technical subjects that are not stated herein will be clearly understood by those skilled in the art from the following specifications.

An aspect of the present disclosure provides a method in which several vehicles that perform platooning in an autonomous driving system (Automated Vehicle & Highway Systems) pass a target vehicle, in which the several vehicles constituting a platoon include a first vehicle controlling platooning and a second vehicle controlled by the first vehicle, and the method includes: checking information of the platoon by means of the first vehicle; requesting information about out-platoon vehicles from a server by means of the first vehicle; receiving the information about the output-platoon vehicles from the server by means of the first vehicle; determining a passing operation of the platoon on the basis of the platoon information and the information about the out-platoon vehicles by means of the first vehicle; transmitting information about the passing operation to the second vehicle by means of the first vehicle; and controlling the several vehicles to pass the target vehicle.

Further, in the method of according to an embodiment of the present disclosure, the information of the platoon may include at least one of the number of vehicles constituting the several vehicles, the shape of the platoon, a destination, a target arrival time, and a predicted arrival time.

Further, in the method of according to an embodiment of the present disclosure, the information about the out-platoon vehicles may include at least one of items of information such as locations, speeds, and lanes of the out-platoon vehicles.

Further, in the method of according to an embodiment of the present disclosure, the determining of a passing operation may include securing a preparation lane in preparation for the case in which passing fails.

Further, in the method of according to an embodiment of the present disclosure, when an out-platoon vehicle enters the preparation lane, the first vehicle may transmit no-entering notification to the out-platoon vehicle through a vehicle network.

Further, in the method of according to an embodiment of the present disclosure, when some vehicles of the several vehicles fail in passing, the some vehicles may move to the preparation lane.

Further, in the method of according to an embodiment of the present disclosure, the shape of the platoon may be deformed in accordance with the number of lanes to be used for passing, the speed of the target vehicle, and the gap between the platoon and the target vehicle.

Further, in the method of according to an embodiment of the present disclosure, the entire platoon may pass the target vehicle while maintaining the shape of the platoon.

Further, in the method of according to an embodiment of the present disclosure, it is possible to monitor a passing situation using at least one device of the first vehicle.

Further, in the method of according to an embodiment of the present disclosure, the method may further include broadcasting information about a lane to be used for passing to the out-platoon vehicles by means of the first vehicle.

Further, in the method of according to an embodiment of the present disclosure, the method may further include receiving permission to use and available time for the lane to be used for passing from the out-platoon vehicles by means of the first vehicle.

Further, in the method of according to an embodiment of the present disclosure, the first vehicle and the server may communicate through V2X.

Further, in the method of according to an embodiment of the present disclosure, the method may further include forming a new shape of platoon with vehicles that have succeeded in passing.

Further, in the method of according to an embodiment of the present disclosure, the new shape may be formed on the basis of the point in time of departing from the platoon.

Further, in the method of according to an embodiment of the present disclosure, the new shape may be formed on the basis of capability of a vehicle.

According to another aspect of the present disclosure, several vehicles pass a target vehicle in an autonomous driving system (Automated Vehicle & Highway Systems), in which the several vehicles perform platooning by constituting a platoon and comprises a first vehicle controlling the platooning and a second vehicle controlled by the first vehicle, in which the first vehicle includes: a communication module; a memory; and a processor, and the processor may check information about the platoon, request information about out-platoon vehicles by controlling the communication module, receive the information about the out-platoon vehicles from the server by controlling the communication module, control the communication module to determine a passing operation of the platoon on the basis of the platoon information and the information about the out-platoon vehicles and to transmit the information about the passing operation to the second vehicle, and perform controlling to pass the target vehicle.

### BRIEF DESCRIPTION OF THE DRAWINGS

The accompanying drawings, which are included as part of the detailed description to help understand the present invention, provide an embodiment of the present invention and together with the description, describe the technical features of the present invention.

FIG. 1 is a block diagram of a wireless communication system to which methods proposed in the disclosure are applicable.

FIG. 2 shows an example of a signal transmission/reception method in a wireless communication system.

FIG. 3 shows an example of basic operations of an autonomous vehicle and a 5G network in a 5G communication system.

FIG. 4 shows an example of a basic operation between vehicles using 5G communication.

FIG. 5 illustrates a vehicle according to an embodiment of the present invention.

FIG. 6 is a control block diagram of the vehicle according to an embodiment of the present invention.

FIG. 7 is a control block diagram of an autonomous device according to an embodiment of the present invention.

FIG. 8 is a diagram showing a signal flow in an autonomous vehicle according to an embodiment of the present invention.

FIG. 9 is a diagram referred to in description of a usage scenario of a user according to an embodiment of the present invention.

FIG. 10 shows an example of a type of V2X application.

FIG. 11 shows an example of a platoon shape in platooning.

FIG. 12 is an example of a configuration view of a server and platoons of vehicles that perform platooning according to an embodiment proposed in the present disclosure.

FIG. 13 is a flowchart about a method of performing a passing operation in platooning according to an embodiment proposed in the present disclosure.

FIG. 14 is a flowchart about a method of performing a passing operation including communication with another platoon in platooning according to an embodiment proposed in the present disclosure.

FIG. 15 is a flowchart related to passing-reattempt when passing is attempted but fails in platooning according to an embodiment proposed in the present disclosure.

FIG. 16 shows an example of an operation flowchart of a vehicle to which the method and embodiment described above can be applied.

FIG. 17 is an example of a passing operation in platooning.

FIG. 18 is an example of a passing operation when several passing routes are set.

FIG. 19 shows an example of setting a return preparation lane.

FIG. 20 is an example of securing a disposition space of all platoon vehicles by preventing entry of another vehicle when only some of platooning vehicles succeed in passing.

FIG. 21 shows an example when a new platoon shape is formed after passing succeeds.

Accompanying drawings included as a part of the detailed description for helping understand the present disclosure provide embodiments of the present disclosure and are provided to describe technical features of the present disclosure with the detailed description.

### DESCRIPTION OF EXEMPLARY EMBODIMENTS

Hereinafter, embodiments of the disclosure will be described in detail with reference to the attached drawings. The same or similar components are given the same reference numbers and redundant description thereof is omitted. The suffixes “module” and “unit” of elements herein are used for convenience of description and thus can be used interchangeably and do not have any distinguishable meanings or functions. Further, in the following description, if a detailed description of known techniques associated with the present invention would unnecessarily obscure the gist of the present invention, detailed description thereof will be omitted. In addition, the attached drawings are provided for easy understanding of embodiments of the disclosure and do not limit technical spirits of the disclosure, and the embodiments should be construed as including all modifications, equivalents, and alternatives falling within the spirit and scope of the embodiments.

While terms, such as “first”, “second”, etc., may be used to describe various components, such components must not be limited by the above terms. The above terms are used only to distinguish one component from another.

When an element is “coupled” or “connected” to another element, it should be understood that a third element may be present between the two elements although the element may be directly coupled or connected to the other element. When an element is “directly coupled” or “directly connected” to another element, it should be understood that no element is present between the two elements.

The singular forms are intended to include the plural forms as well, unless the context clearly indicates otherwise.

In addition, in the specification, it will be further understood that the terms “comprise” and “include” specify the presence of stated features, integers, steps, operations, elements, components, and/or combinations thereof, but do not preclude the presence or addition of one or more other features, integers, steps, operations, elements, components, and/or combinations.

### A. Example of Block Diagram of UE and 5G Network

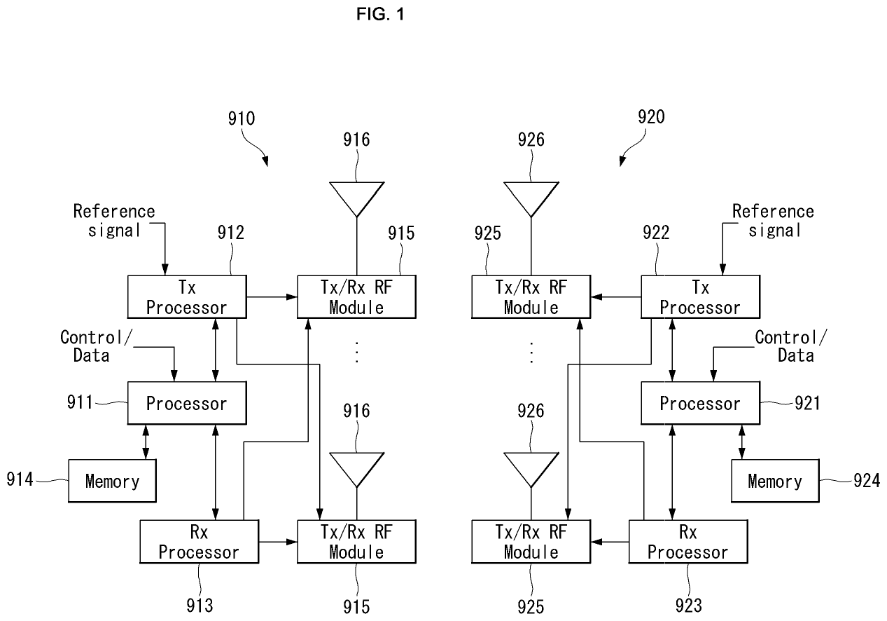

FIG. 1 is a block diagram of a wireless communication system to which methods proposed in the disclosure are applicable.

Referring to FIG. 1, a device (autonomous device) including an autonomous module is defined as a first communication device (910 of FIG. 1), and a processor 911 can perform detailed autonomous operations.

A 5G network including another vehicle communicating with the autonomous device is defined as a second communication device (920 of FIG. 1), and a processor 921 can perform detailed autonomous operations.

The 5G network may be represented as the first communication device and the autonomous device may be represented as the second communication device.

For example, the first communication device or the second communication device may be a base station, a network node, a transmission terminal, a reception terminal, a wireless device, a wireless communication device, an autonomous device, or the like.

For example, a terminal or user equipment (UE) may include a vehicle, a cellular phone, a smart phone, a laptop computer, a digital broadcast terminal, personal digital assistants (PDAs), a portable multimedia player (PMP), a navigation device, a slate PC, a tablet PC, an ultrabook, a wearable device (e.g., a smartwatch, a smart glass and a head mounted display (HMD)), etc. For example, the HMD may be a display device worn on the head of a user. For example, the HMD may be used to realize VR, AR or MR. Referring to FIG. 1, the first communication device 910 and the second communication device 920 include processors 911 and 921, memories 914 and 924, one or more Tx/Rx radio frequency (RF) modules 915 and 925, Tx processors 912 and 922, Rx processors 913 and 923, and antennas 916 and 926. The Tx/Rx module is also referred to as a transceiver. Each Tx/Rx module 915 transmits a signal through each antenna 926. The processor implements the aforementioned functions, processes and/or methods. The processor 921 may be related to the memory 924 that stores program code and data. The memory may be referred to as a computer-readable medium. More specifically, the Tx processor 912 implements various signal processing functions with respect to L1 (i.e., physical layer) in DL (communication from the first communication device to the second communication device). The Rx processor implements various signal processing functions of L1 (i.e., physical layer).

UL (communication from the second communication device to the first communication device) is processed in the first communication device 910 in a way similar to that described in association with a receiver function in the second communication device 920. Each Tx/Rx module 925 receives a signal through each antenna 926. Each Tx/Rx module provides RF carriers and information to the Rx processor 923. The processor 921 may be related to the memory 924 that stores program code and data. The memory may be referred to as a computer-readable medium.

### B. Signal Transmission/Reception Method in Wireless Communication System

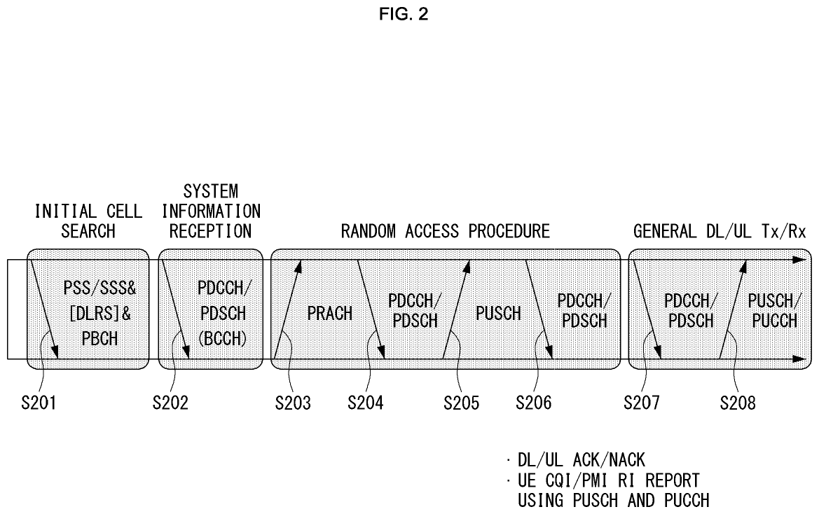

FIG. 2 is a diagram showing an example of a signal transmission/reception method in a wireless communication system.

Referring to FIG. 2, when a UE is powered on or enters a new cell, the UE performs an initial cell search operation such as synchronization with a BS (S201). For this operation, the UE can receive a primary synchronization channel (P-SCH) and a secondary synchronization channel (S-SCH) from the BS to synchronize with the BS and acquire information such as a cell ID. In LTE and NR systems, the P-SCH and S-SCH are respectively called a primary synchronization signal (PSS) and a secondary synchronization signal (SSS). After initial cell search, the UE can acquire broadcast information in the cell by receiving a physical broadcast channel (PBCH) from the BS. Further, the UE can receive a downlink reference signal (DL RS) in the initial cell search step to check a downlink channel state. After initial cell search, the UE can acquire more detailed system information by receiving a physical downlink shared channel (PDSCH) according to a physical downlink control channel (PDCCH) and information included in the PDCCH (S202).

Meanwhile, when the UE initially accesses the BS or has no radio resource for signal transmission, the UE can perform a random access procedure (RACH) for the BS (steps S203 to S206). To this end, the UE can transmit a specific sequence as a preamble through a physical random access channel (PRACH) (S203 and S205) and receive a random access response (RAR) message for the preamble through a PDCCH and a corresponding PDSCH (S204 and S206). In the case of a contention-based RACH, a contention resolution procedure may be additionally performed.

After the UE performs the above-described process, the UE can perform PDCCH/PDSCH reception (S207) and physical uplink shared channel (PUSCH)/physical uplink control channel (PUCCH) transmission (S208) as normal uplink/downlink signal transmission processes. Particularly, the UE receives downlink control information (DCI) through the PDCCH. The UE monitors a set of PDCCH candidates in monitoring occasions set for one or more control element sets (CORESET) on a serving cell according to corresponding search space configurations. A set of PDCCH candidates to be monitored by the UE is defined in terms of search space sets, and a search space set may be a common search space set or a UE-specific search space set. CORESET includes a set of (physical) resource blocks having a duration of one to three OFDM symbols. A network can configure the UE such that the UE has a plurality of CORESETs. The UE monitors PDCCH candidates in one or more search space sets. Here, monitoring means attempting decoding of PDCCH candidate(s) in a search space. When the UE has successfully decoded one of PDCCH candidates in a search space, the UE determines that a PDCCH has been detected from the PDCCH candidate and performs PDSCH reception or PUSCH transmission on the basis of DCI in the detected PDCCH. The PDCCH can be used to schedule DL transmissions over a PDSCH and UL transmissions over a PUSCH. Here, the DCI in the PDCCH includes downlink assignment (i.e., downlink grant (DL grant)) related to a physical downlink shared channel and including at least a modulation and coding format and resource allocation information, or an uplink grant (UL grant) related to a physical uplink shared channel and including a modulation and coding format and resource allocation information.

An initial access (IA) procedure in a 5G communication system will be additionally described with reference to FIG. 2.

The UE can perform cell search, system information acquisition, beam alignment for initial access, and DL measurement on the basis of an SSB. The SSB is interchangeably used with a synchronization signal/physical broadcast channel (SS/PBCH) block.

The SSB includes a PSS, an SSS and a PBCH. The SSB is configured in four consecutive OFDM symbols, and a PSS, a PBCH, an SSS/PBCH or a PBCH is transmitted for each OFDM symbol. Each of the PSS and the SSS includes one OFDM symbol and 127 subcarriers, and the PBCH includes 3 OFDM symbols and 576 subcarriers.

Cell search refers to a process in which a UE acquires time/frequency synchronization of a cell and detects a cell identifier (ID) (e.g., physical layer cell ID (PCI)) of the cell. The PSS is used to detect a cell ID in a cell ID group and the SSS is used to detect a cell ID group. The PBCH is used to detect an SSB (time) index and a half-frame.

There are 336 cell ID groups and there are 3 cell IDs per cell ID group. A total of 1008 cell IDs are present. Information on a cell ID group to which a cell ID of a cell belongs is provided/acquired through an SSS of the cell, and information on the cell ID among 336 cell ID groups is provided/acquired through a PSS.

The SSB is periodically transmitted in accordance with SSB periodicity. A default SSB periodicity assumed by a UE during initial cell search is defined as 20 ms. After cell access, the SSB periodicity can be set to one of {5 ms, 10 ms, 20 ms, 40 ms, 80 ms, 160 ms} by a network (e.g., a BS).

Next, acquisition of system information (SI) will be described.

SI is divided into a master information block (MIB) and a plurality of system information blocks (SIBs). SI other than the MIB may be referred to as remaining minimum system information. The MIB includes information/parameter for monitoring a PDCCH that schedules a PDSCH carrying SIB1 (SystemInformationBlock1) and is transmitted by a BS through a PBCH of an SSB. SIB1 includes information related to availability and scheduling (e.g., transmission periodicity and SI-window size) of the remaining SIBs (hereinafter, SIBx, x is an integer equal to or greater than 2). SiBx is included in an SI message and transmitted over a PDSCH. Each SI message is transmitted within a periodically generated time window (i.e., SI-window).

A random access (RA) procedure in a 5G communication system will be additionally described with reference to FIG. 2.

A random access procedure is used for various purposes. For example, the random access procedure can be used for network initial access, handover, and UE-triggered UL data transmission. A UE can acquire UL synchronization and UL transmission resources through the random access procedure. The random access procedure is classified into a contention-based random access procedure and a contention-free random access procedure. A detailed procedure for the contention-based random access procedure is as follows.

A UE can transmit a random access preamble through a PRACH as Msg1 of a random access procedure in UL. Random access preamble sequences having different two lengths are supported. A long sequence length 839 is applied to subcarrier spacings of 1.25 kHz and 5 kHz and a short sequence length 139 is applied to subcarrier spacings of 15 kHz, 30 kHz, 60 kHz and 120 kHz.

When a BS receives the random access preamble from the UE, the BS transmits a random access response (RAR) message (Msg2) to the UE. A PDCCH that schedules a PDSCH carrying a RAR is CRC masked by a random access (RA) radio network temporary identifier (RNTI) (RA-RNTI) and transmitted. Upon detection of the PDCCH masked by the RA-RNTI, the UE can receive a RAR from the PDSCH scheduled by DCI carried by the PDCCH. The UE checks whether the RAR includes random access response information with respect to the preamble transmitted by the UE, that is, Msg1. Presence or absence of random access information with respect to Msg1 transmitted by the UE can be determined according to presence or absence of a random access preamble ID with respect to the preamble transmitted by the UE. If there is no response to Msg1, the UE can retransmit the RACH preamble less than a predetermined number of times while performing power ramping. The UE calculates PRACH transmission power for preamble retransmission on the basis of most recent pathloss and a power ramping counter.

The UE can perform UL transmission through Msg3 of the random access procedure over a physical uplink shared channel on the basis of the random access response information. Msg3 can include an RRC connection request and a UE ID. The network can transmit Msg4 as a response to Msg3, and Msg4 can be handled as a contention resolution message on DL. The UE can enter an RRC connected state by receiving Msg4.

### C. Beam Management (BM) Procedure of 5G Communication System

A BM procedure can be divided into (1) a DL MB procedure using an SSB or a CSI-RS and (2) a UL BM procedure using a sounding reference signal (SRS). In addition, each BM procedure can include Tx beam swiping for determining a Tx beam and Rx beam swiping for determining an Rx beam.

The DL BM procedure using an SSB will be described.

Configuration of a beam report using an SSB is performed when channel state information (CSI)/beam is configured in RRC_CONNECTED.
A UE receives a CSI-ResourceConfig IE including CSI-SSB-ResourceSetList for SSB resources used for BM from a BS. The RRC parameter “csi-SSB-ResourceSetList”represents a list of SSB resources used for beam management and report in one resource set. Here, an SSB resource set can be set as {SSBx1, SSBx2, SSBx3, SSBx4, . . . }. An SSB index can be defined in the range of 0 to 63.
The UE receives the signals on SSB resources from the BS on the basis of the CSI-SSB-ResourceSetList.
When CSI-RS reportConfig with respect to a report on SSBRI and reference signal received power (RSRP) is set, the UE reports the best SSBRI and RSRP corresponding thereto to the BS. For example, when reportQuantity of the CSI-RS reportConfig IE is set to ‘ssb-Index-RSRP’, the UE reports the best SSBRI and RSRP corresponding thereto to the BS.

When a CSI-RS resource is configured in the same OFDM symbols as an SSB and ‘QCL-TypeD’ is applicable, the UE can assume that the CSI-RS and the SSB are quasi co-located (QCL) from the viewpoint of ‘QCL-TypeD’. Here, QCL-TypeD may mean that antenna ports are quasi co-located from the viewpoint of a spatial Rx parameter. When the UE receives signals of a plurality of DL antenna ports in a QCL-TypeD relationship, the same Rx beam can be applied.

Next, a DL BM procedure using a CSI-RS will be described.

An Rx beam determination (or refinement) procedure of a UE and a Tx beam swiping procedure of a BS using a CSI-RS will be sequentially described. A repetition parameter is set to ‘ON’ in the Rx beam determination procedure of a UE and set to ‘OFF’ in the Tx beam swiping procedure of a BS.

First, the Rx beam determination procedure of a UE will be described.
The UE receives an NZP CSI-RS resource set IE including an RRC parameter with respect to ‘repetition’ from a BS through RRC signaling. Here, the RRC parameter ‘repetition’ is set to ‘ON’.
The UE repeatedly receives signals on resources in a CSI-RS resource set in which the RRC parameter ‘repetition’ is set to ‘ON’ in different OFDM symbols through the same Tx beam (or DL spatial domain transmission filters) of the BS.
The UE determines an RX beam thereof.
The UE skips a CSI report. That is, the UE can skip a CSI report when the RRC parameter ‘repetition’ is set to ‘ON’.

Next, the Tx beam determination procedure of a BS will be described.
A UE receives an NZP CSI-RS resource set IE including an RRC parameter with respect to ‘repetition’ from the BS through RRC signaling. Here, the RRC parameter ‘repetition’ is related to the Tx beam swiping procedure of the BS when set to ‘OFF’.
The UE receives signals on resources in a CSI-RS resource set in which the RRC parameter ‘repetition’ is set to ‘OFF’ in different DL spatial domain transmission filters of the BS.
The UE selects (or determines) a best beam.
The UE reports an ID (e.g., CRI) of the selected beam and related quality information (e.g., RSRP) to the BS. That is, when a CSI-RS is transmitted for BM, the UE reports a CRI and RSRP with respect thereto to the BS.

Next, the UL BM procedure using an SRS will be described.
A UE receives RRC signaling (e.g., SRS-Config IE) including a (RRC parameter) purpose parameter set to ‘beam management’ from a BS. The SRS-Config IE is used to set SRS transmission. The SRS-Config IE includes a list of SRS-Resources and a list of SRS-ResourceSets. Each SRS resource set refers to a set of SRS-resources.

The UE determines Tx beamforming for SRS resources to be transmitted on the basis of SRS-SpatialRelation Info included in the SRS-Config IE. Here, SRS-SpatialRelation Info is set for each SRS resource and indicates whether the same beamforming as that used for an SSB, a CSI-RS or an SRS will be applied for each SRS resource.
When SRS-SpatialRelationInfo is set for SRS resources, the same beamforming as that used for the SSB, CSI-RS or SRS is applied. However, when SRS-SpatialRelationInfo is not set for SRS resources, the UE arbitrarily determines Tx beamforming and transmits an SRS through the determined Tx beamforming.

Next, a beam failure recovery (BFR) procedure will be described.

In a beamformed system, radio link failure (RLF) may frequently occur due to rotation, movement or beamforming blockage of a UE. Accordingly, NR supports BFR in order to prevent frequent occurrence of RLF. BFR is similar to a radio link failure recovery procedure and can be supported when a UE knows new candidate beams. For beam failure detection, a BS configures beam failure detection reference signals for a UE, and the UE declares beam failure when the number of beam failure indications from the physical layer of the UE reaches a threshold set through RRC signaling within a period set through RRC signaling of the BS. After beam failure detection, the UE triggers beam failure recovery by initiating a random access procedure in a PCell and performs beam failure recovery by selecting a suitable beam. (When the BS provides dedicated random access resources for certain beams, these are prioritized by the UE). Completion of the aforementioned random access procedure is regarded as completion of beam failure recovery.

### D. URLLC (Ultra-Reliable and Low Latency Communication)

URLLC transmission defined in NR can refer to (1) a relatively low traffic size, (2) a relatively low arrival rate, (3) extremely low latency requirements (e.g., 0.5 and 1 ms), (4) relatively short transmission duration (e.g., 2 OFDM symbols), (5) urgent services/messages, etc. In the case of UL, transmission of traffic of a specific type (e.g., URLLC) needs to be multiplexed with another transmission (e.g., eMBB) scheduled in advance in order to satisfy more stringent latency requirements. In this regard, a method of providing information indicating preemption of specific resources to a UE scheduled in advance and allowing a URLLC UE to use the resources for UL transmission is provided.

NR supports dynamic resource sharing between eMBB and URLLC. eMBB and URLLC services can be scheduled on non-overlapping time/frequency resources, and URLLC transmission can occur in resources scheduled for ongoing eMBB traffic. An eMBB UE may not ascertain whether PDSCH transmission of the corresponding UE has been partially punctured and the UE may not decode a PDSCH due to corrupted coded bits. In view of this, NR provides a preemption indication. The preemption indication may also be referred to as an interrupted transmission indication.

With regard to the preemption indication, a UE receives DownlinkPreemption IE through RRC signaling from a BS. When the UE is provided with DownlinkPreemption IE, the UE is configured with INT-RNTI provided by a parameter int-RNTI in DownlinkPreemption IE for monitoring of a PDCCH that conveys DCI format 2_1. The UE is additionally configured with a corresponding set of positions for fields in DCI format 2_1 according to a set of serving cells and positionInDCI by INT-ConfigurationPerServing Cell including a set of serving cell indexes provided by servingCellID, configured having an information payload size for DCI format 2_1 according to dci-Payloadsize, and configured with indication granularity of time-frequency resources according to timeFrequencySect.

The UE receives DCI format 2_1 from the BS on the basis of the DownlinkPreemption IE.

When the UE detects DCI format 2_1 for a serving cell in a configured set of serving cells, the UE can assume that there is no transmission to the UE in PRBs and symbols indicated by the DCI format 2_1 in a set of PRBs and a set of symbols in a last monitoring period before a monitoring period to which the DCI format 2_1 belongs. For example, the UE assumes that a signal in a time-frequency resource indicated according to preemption is not DL transmission scheduled therefor and decodes data on the basis of signals received in the remaining resource region.

### E. mMTC (Massive MTC)

mMTC (massive Machine Type Communication) is one of 5G scenarios for supporting a hyper-connection service providing simultaneous communication with a large number of UEs. In this environment, a UE intermittently performs communication with a very low speed and mobility. Accordingly, a main goal of mMTC is operating a UE for a long time at a low cost. With respect to mMTC, 3GPP deals with MTC and NB (NarrowBand)-IoT.

mMTC has features such as repetitive transmission of a PDCCH, a PUCCH, a PDSCH (physical downlink shared channel), a PUSCH, etc., frequency hopping, retuning, and a guard period.

That is, a PUSCH (or a PUCCH (particularly, a long PUCCH) or a PRACH) including specific information and a PDSCH (or a PDCCH) including a response to the specific information are repeatedly transmitted. Repetitive transmission is performed through frequency hopping, and for repetitive transmission, (RF) retuning from a first frequency resource to a second frequency resource is performed in a guard period and the specific information and the response to the specific information can be transmitted/received through a narrowband (e.g., 6 resource blocks (RBs) or 1 RB).

### F. Basic Operation Between Autonomous Vehicles Using 5G Communication

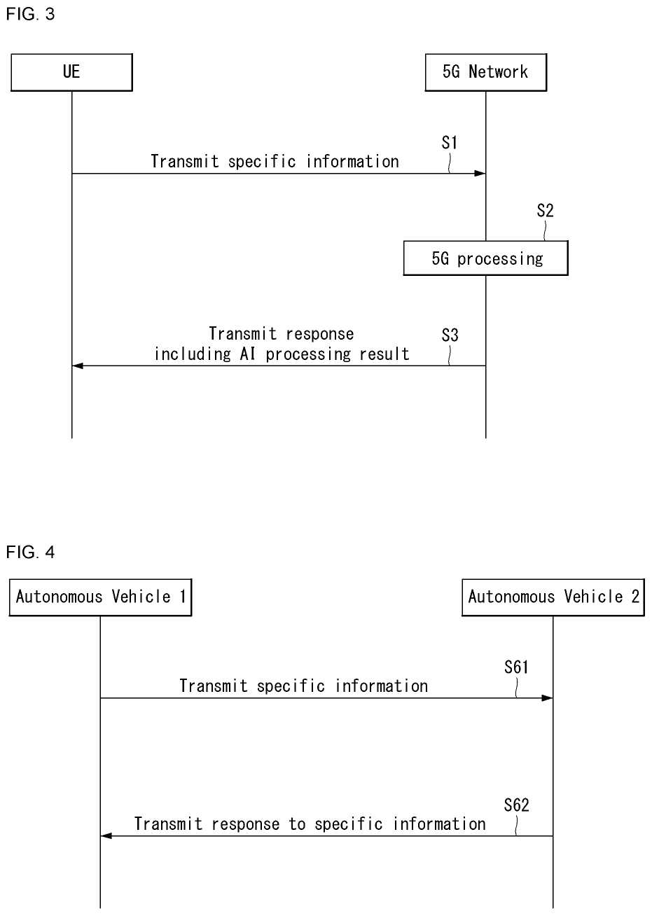

FIG. 3 shows an example of basic operations of an autonomous vehicle and a 5G network in a 5G communication system.

The autonomous vehicle transmits specific information to the 5G network (S1). The specific information may include autonomous driving related information. In addition, the 5G network can determine whether to remotely control the vehicle (S2). Here, the 5G network may include a server or a module which performs remote control related to autonomous driving. In addition, the 5G network can transmit information (or signal) related to remote control to the autonomous vehicle (S3).

### G. Applied Operations Between Autonomous Vehicle and 5G Network in 5G Communication System

Hereinafter, the operation of an autonomous vehicle using 5G communication will be described in more detail with reference to wireless communication technology (BM procedure, URLLC, mMTC, etc.) described in FIGS. 1 and 2.

First, a basic procedure of an applied operation to which a method proposed by the present invention which will be described later and eMBB of 5G communication are applied will be described.

As in steps S1 and S3 of FIG. 3, the autonomous vehicle performs an initial access procedure and a random access procedure with the 5G network prior to step S1 of FIG. 3 in order to transmit/receive signals, information and the like to/from the 5G network.

More specifically, the autonomous vehicle performs an initial access procedure with the 5G network on the basis of an SSB in order to acquire DL synchronization and system information. A beam management (BM) procedure and a beam failure recovery procedure may be added in the initial access procedure, and quasi-co-location (QCL) relation may be added in a process in which the autonomous vehicle receives a signal from the 5G network.

In addition, the autonomous vehicle performs a random access procedure with the 5G network for UL synchronization acquisition and/or UL transmission. The 5G network can transmit, to the autonomous vehicle, a UL grant for scheduling transmission of specific information. Accordingly, the autonomous vehicle transmits the specific information to the 5G network on the basis of the UL grant. In addition, the 5G network transmits, to the autonomous vehicle, a DL grant for scheduling transmission of 5G processing results with respect to the specific information. Accordingly, the 5G network can transmit, to the autonomous vehicle, information (or a signal) related to remote control on the basis of the DL grant.

Next, a basic procedure of an applied operation to which a method proposed by the present invention which will be described later and URLLC of 5G communication are applied will be described.

As described above, an autonomous vehicle can receive DownlinkPreemption IE from the 5G network after the autonomous vehicle performs an initial access procedure and/or a random access procedure with the 5G network. Then, the autonomous vehicle receives DCI format 2_1 including a preemption indication from the 5G network on the basis of DownlinkPreemption IE. The autonomous vehicle does not perform (or expect or assume) reception of eMBB data in resources (PRBs and/or OFDM symbols) indicated by the preemption indication. Thereafter, when the autonomous vehicle needs to transmit specific information, the autonomous vehicle can receive a UL grant from the 5G network.

Next, a basic procedure of an applied operation to which a method proposed by the present invention which will be described later and mMTC of 5G communication are applied will be described.

Description will focus on parts in the steps of FIG. 3 which are changed according to application of mMTC.

In step S1 of FIG. 3, the autonomous vehicle receives a UL grant from the 5G network in order to transmit specific information to the 5G network. Here, the UL grant may include information on the number of repetitions of transmission of the specific information and the specific information may be repeatedly transmitted on the basis of the information on the number of repetitions. That is, the autonomous vehicle transmits the specific information to the 5G network on the basis of the UL grant. Repetitive transmission of the specific information may be performed through frequency hopping, the first transmission of the specific information may be performed in a first frequency resource, and the second transmission of the specific information may be performed in a second frequency resource. The specific information can be transmitted through a narrowband of 6 resource blocks (RBs) or 1 RB.

### H. Autonomous Driving Operation Between Vehicles Using 5G Communication

FIG. 4 shows an example of a basic operation between vehicles using 5G communication.

A first vehicle transmits specific information to a second vehicle (S61). The second vehicle transmits a response to the specific information to the first vehicle (S62).

Meanwhile, a configuration of an applied operation between vehicles may depend on whether the 5G network is directly (sidelink communication transmission mode 3) or indirectly (sidelink communication transmission mode 4) involved in resource allocation for the specific information and the response to the specific information.

Next, an applied operation between vehicles using 5G communication will be described.

First, a method in which a 5G network is directly involved in resource allocation for signal transmission/reception between vehicles will be described.

The 5G network can transmit DCI format 5A to the first vehicle for scheduling of mode-3 transmission (PSCCH and/or PSSCH transmission). Here, a physical sidelink control channel (PSCCH) is a 5G physical channel for scheduling of transmission of specific information a physical sidelink shared channel (PSSCH) is a 5G physical channel for transmission of specific information. In addition, the first vehicle transmits SCI format 1 for scheduling of specific information transmission to the second vehicle over a PSCCH. Then, the first vehicle transmits the specific information to the second vehicle over a PSSCH.

Next, a method in which a 5G network is indirectly involved in resource allocation for signal transmission/reception will be described.

The first vehicle senses resources for mode-4 transmission in a first window. Then, the first vehicle selects resources for mode-4 transmission in a second window on the basis of the sensing result. Here, the first window refers to a sensing window and the second window refers to a selection window. The first vehicle transmits SCI format 1 for scheduling of transmission of specific information to the second vehicle over a PSCCH on the basis of the selected resources. Then, the first vehicle transmits the specific information to the second vehicle over a PSSCH.

The above-described 5G communication technology can be combined with methods proposed in the present invention which will be described later and applied or can complement the methods proposed in the present invention to make technical features of the methods concrete and clear.

Driving

(1) Exterior of Vehicle

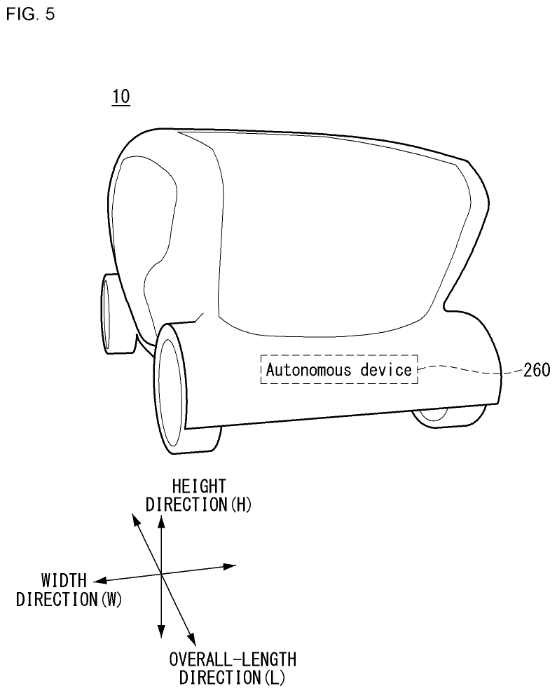

FIG. 5 is a diagram showing a vehicle according to an embodiment of the present invention.

Referring to FIG. 5, a vehicle 10 according to an embodiment of the present invention is defined as a transportation means traveling on roads or railroads. The vehicle 10 includes a car, a train and a motorcycle. The vehicle 10 may include an internal-combustion engine vehicle having an engine as a power source, a hybrid vehicle having an engine and a motor as a power source, and an electric vehicle having an electric motor as a power source. The vehicle 10 may be a private own vehicle. The vehicle 10 may be a shared vehicle. The vehicle 10 may be an autonomous vehicle.

(2) Components of Vehicle

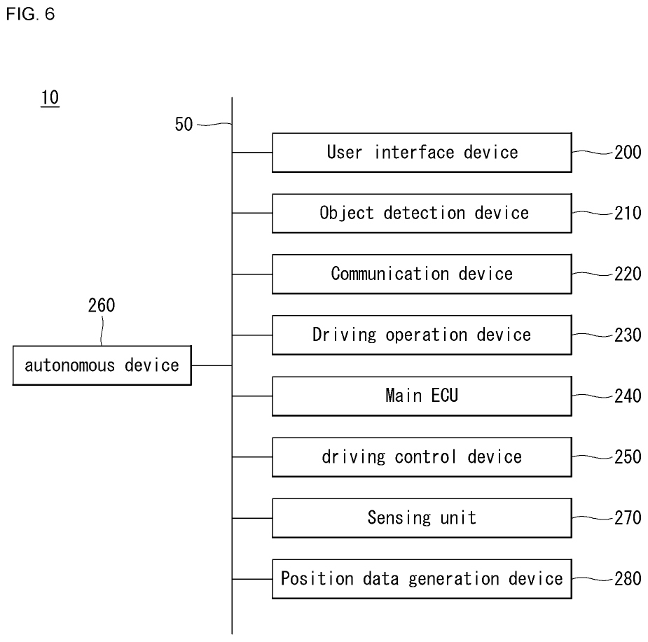

FIG. 6 is a control block diagram of the vehicle according to an embodiment of the present invention.

Referring to FIG. 6, the vehicle 10 may include a user interface device 200, an object detection device 210, a communication device 220, a driving operation device 230, a main ECU 240, a driving control device 250, an autonomous device 260, a sensing unit 270, and a position data generation device 280. The object detection device 210, the communication device 220, the driving operation device 230, the main ECU 240, the driving control device 250, the autonomous device 260, the sensing unit 270 and the position data generation device 280 may be realized by electronic devices which generate electric signals and exchange the electric signals from one another.

1) User Interface Device

The user interface device 200 is a device for communication between the vehicle 10 and a user. The user interface device 200 can receive user input and provide information generated in the vehicle 10 to the user. The vehicle 10 can realize a user interface (UI) or user experience (UX) through the user interface device 200. The user interface device 200 may include an input device, an output device and a user monitoring device.

2) Object Detection Device

The object detection device 210 can generate information about objects outside the vehicle 10. Information about an object can include at least one of information on presence or absence of the object, positional information of the object, information on a distance between the vehicle 10 and the object, and information on a relative speed of the vehicle 10 with respect to the object. The object detection device 210 can detect objects outside the vehicle 10. The object detection device 210 may include at least one sensor which can detect objects outside the vehicle 10. The object detection device 210 may include at least one of a camera, a radar, a lidar, an ultrasonic sensor and an infrared sensor. The object detection device 210 can provide data about an object generated on the basis of a sensing signal generated from a sensor to at least one electronic device included in the vehicle.

2.1) Camera

The camera can generate information about objects outside the vehicle 10 using images. The camera may include at least one lens, at least one image sensor, and at least one processor which is electrically connected to the image sensor, processes received signals and generates data about objects on the basis of the processed signals.

The camera may be at least one of a mono camera, a stereo camera and an around view monitoring (AVM) camera. The camera can acquire positional information of objects, information on distances to objects, or information on relative speeds with respect to objects using various image processing algorithms. For example, the camera can acquire information on a distance to an object and information on a relative speed with respect to the object from an acquired image on the basis of change in the size of the object over time. For example, the camera may acquire information on a distance to an object and information on a relative speed with respect to the object through a pin-hole model, road profiling, or the like. For example, the camera may acquire information on a distance to an object and information on a relative speed with respect to the object from a stereo image acquired from a stereo camera on the basis of disparity information.

The camera may be attached at a portion of the vehicle at which FOV (field of view) can be secured in order to photograph the outside of the vehicle. The camera may be disposed in proximity to the front windshield inside the vehicle in order to acquire front view images of the vehicle. The camera may be disposed near a front bumper or a radiator grill. The camera may be disposed in proximity to a rear glass inside the vehicle in order to acquire rear view images of the vehicle. The camera may be disposed near a rear bumper, a trunk or a tail gate. The camera may be disposed in proximity to at least one of side windows inside the vehicle in order to acquire side view images of the vehicle. Alternatively, the camera may be disposed near a side mirror, a fender or a door.

2.2) Radar

The radar can generate information about an object outside the vehicle using electromagnetic waves. The radar may include an electromagnetic wave transmitter, an electromagnetic wave receiver, and at least one processor which is electrically connected to the electromagnetic wave transmitter and the electromagnetic wave receiver, processes received signals and generates data about an object on the basis of the processed signals. The radar may be realized as a pulse radar or a continuous wave radar in terms of electromagnetic wave emission. The continuous wave radar may be realized as a frequency modulated continuous wave (FMCW) radar or a frequency shift keying (FSK) radar according to signal waveform. The radar can detect an object through electromagnetic waves on the basis of TOF (Time of Flight) or phase shift and detect the position of the detected object, a distance to the detected object and a relative speed with respect to the detected object. The radar may be disposed at an appropriate position outside the vehicle in order to detect objects positioned in front of, behind or on the side of the vehicle.

2.3 Lidar

The lidar can generate information about an object outside the vehicle 10 using a laser beam. The lidar may include a light transmitter, a light receiver, and at least one processor which is electrically connected to the light transmitter and the light receiver, processes received signals and generates data about an object on the basis of the processed signal. The lidar may be realized according to TOF or phase shift. The lidar may be realized as a driven type or a non-driven type. A driven type lidar may be rotated by a motor and detect an object around the vehicle 10. A non-driven type lidar may detect an object positioned within a predetermined range from the vehicle according to light steering. The vehicle 10 may include a plurality of non-drive type lidars. The lidar can detect an object through a laser beam on the basis of TOF (Time of Flight) or phase shift and detect the position of the detected object, a distance to the detected object and a relative speed with respect to the detected object. The lidar may be disposed at an appropriate position outside the vehicle in order to detect objects positioned in front of, behind or on the side of the vehicle.

3) Communication Device

The communication device 220 can exchange signals with devices disposed outside the vehicle 10. The communication device 220 can exchange signals with at least one of infrastructure (e.g., a server and a broadcast station), another vehicle and a terminal. The communication device 220 may include a transmission antenna, a reception antenna, and at least one of a radio frequency (RF) circuit and an RF element which can implement various communication protocols in order to perform communication.

For example, the communication device can exchange signals with external devices on the basis of C-V2X (Cellular V2X). For example, C-V2X can include sidelink communication based on LTE and/or sidelink communication based on NR. Details related to C-V2X will be described later.

For example, the communication device can exchange signals with external devices on the basis of DSRC (Dedicated Short Range Communications) or WAVE (Wireless Access in Vehicular Environment) standards based on IEEE 802.11p PHY/MAC layer technology and IEEE 1609 Network/Transport layer technology. DSRC (or WAVE standards) is communication specifications for providing an intelligent transport system (ITS) service through short-range dedicated communication between vehicle-mounted devices or between a roadside device and a vehicle-mounted device. DSRC may be a communication scheme that can use a frequency of 5.9 GHz and have a data transfer rate in the range of 3 Mbps to 27 Mbps. IEEE 802.11p may be combined with IEEE 1609 to support DSRC (or WAVE standards).

The communication device of the present invention can exchange signals with external devices using only one of C-V2X and DSRC. Alternatively, the communication device of the present invention can exchange signals with external devices using a hybrid of C-V2X and DSRC.

4) Driving Operation Device

The driving operation device 230 is a device for receiving user input for driving. In a manual mode, the vehicle 10 may be driven on the basis of a signal provided by the driving operation device 230. The driving operation device 230 may include a steering input device (e.g., a steering wheel), an acceleration input device (e.g., an acceleration pedal) and a brake input device (e.g., a brake pedal).

5) Main ECU

The main ECU 240 can control the overall operation of at least one electronic device included in the vehicle 10.

6) Driving Control Device

The driving control device 250 is a device for electrically controlling various vehicle driving devices included in the vehicle 10. The driving control device 250 may include a power train driving control device, a chassis driving control device, a door/window driving control device, a safety device driving control device, a lamp driving control device, and an air-conditioner driving control device. The power train driving control device may include a power source driving control device and a transmission driving control device. The chassis driving control device may include a steering driving control device, a brake driving control device and a suspension driving control device. Meanwhile, the safety device driving control device may include a seat belt driving control device for seat belt control.

The driving control device 250 includes at least one electronic control device (e.g., a control ECU (Electronic Control Unit)).

The driving control device 250 can control vehicle driving devices on the basis of signals received by the autonomous device 260. For example, the driving control device 250 can control a power train, a steering device and a brake device on the basis of signals received by the autonomous device 260.

7) Autonomous Device

The autonomous device 260 can generate a route for self-driving on the basis of acquired data. The autonomous device 260 can generate a driving plan for traveling along the generated route. The autonomous device 260 can generate a signal for controlling movement of the vehicle according to the driving plan. The autonomous device 260 can provide the signal to the driving control device 250.

The autonomous device 260 can implement at least one ADAS (Advanced Driver Assistance System) function. The ADAS can implement at least one of ACC (Adaptive Cruise Control), AEB (Autonomous Emergency Braking), FCW (Forward Collision Warning), LKA (Lane Keeping Assist), LCA (Lane Change Assist), TFA (Target Following Assist), BSD (Blind Spot Detection), HBA (High Beam Assist), APS (Auto Parking System), a PD collision warning system, TSR (Traffic Sign Recognition), TSA (Traffic Sign Assist), NV (Night Vision), DSM (Driver Status Monitoring) and TJA (Traffic Jam Assist).

The autonomous device 260 can perform switching from a self-driving mode to a manual driving mode or switching from the manual driving mode to the self-driving mode. For example, the autonomous device 260 can switch the mode of the vehicle 10 from the self-driving mode to the manual driving mode or from the manual driving mode to the self-driving mode on the basis of a signal received from the user interface device 200.

8) Sensing Unit

The sensing unit 270 can detect a state of the vehicle. The sensing unit 270 may include at least one of an internal measurement unit (IMU) sensor, a collision sensor, a wheel sensor, a speed sensor, an inclination sensor, a weight sensor, a heading sensor, a position module, a vehicle forward/backward movement sensor, a battery sensor, a fuel sensor, a tire sensor, a steering sensor, a temperature sensor, a humidity sensor, an ultrasonic sensor, an illumination sensor, and a pedal position sensor. Further, the IMU sensor may include one or more of an acceleration sensor, a gyro sensor and a magnetic sensor.

The sensing unit 270 can generate vehicle state data on the basis of a signal generated from at least one sensor. Vehicle state data may be information generated on the basis of data detected by various sensors included in the vehicle. The sensing unit 270 may generate vehicle attitude data, vehicle motion data, vehicle yaw data, vehicle roll data, vehicle pitch data, vehicle collision data, vehicle orientation data, vehicle angle data, vehicle speed data, vehicle acceleration data, vehicle tilt data, vehicle forward/backward movement data, vehicle weight data, battery data, fuel data, tire pressure data, vehicle internal temperature data, vehicle internal humidity data, steering wheel rotation angle data, vehicle external illumination data, data of a pressure applied to an acceleration pedal, data of a pressure applied to a brake panel, etc.

9) Position Data Generation Device

The position data generation device 280 can generate position data of the vehicle 10. The position data generation device 280 may include at least one of a global positioning system (GPS) and a differential global positioning system (DGPS). The position data generation device 280 can generate position data of the vehicle 10 on the basis of a signal generated from at least one of the GPS and the DGPS. According to an embodiment, the position data generation device 280 can correct position data on the basis of at least one of the inertial measurement unit (IMU) sensor of the sensing unit 270 and the camera of the object detection device 210. The position data generation device 280 may also be called a global navigation satellite system (GNSS).

The vehicle 10 may include an internal communication system 50. The plurality of electronic devices included in the vehicle 10 can exchange signals through the internal communication system 50. The signals may include data. The internal communication system 50 can use at least one communication protocol (e.g., CAN, LIN, FlexRay, MOST or Ethernet).

(3) Components of Autonomous Device

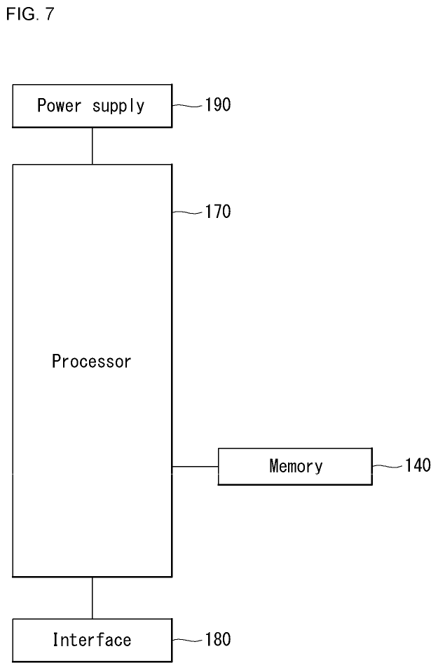

FIG. 7 is a control block diagram of the autonomous device according to an embodiment of the present invention.

Referring to FIG. 7, the autonomous device 260 may include a memory 140, a processor 170, an interface 180 and a power supply 190.

The memory 140 is electrically connected to the processor 170. The memory 140 can store basic data with respect to units, control data for operation control of units, and input/output data. The memory 140 can store data processed in the processor 170. Hardware-wise, the memory 140 can be configured as at least one of a ROM, a RAM, an EPROM, a flash drive and a hard drive. The memory 140 can store various types of data for overall operation of the autonomous device 260, such as a program for processing or control of the processor 170. The memory 140 may be integrated with the processor 170. According to an embodiment, the memory 140 may be categorized as a subcomponent of the processor 170.

The interface 180 can exchange signals with at least one electronic device included in the vehicle 10 in a wired or wireless manner. The interface 180 can exchange signals with at least one of the object detection device 210, the communication device 220, the driving operation device 230, the main ECU 240, the driving control device 250, the sensing unit 270 and the position data generation device 280 in a wired or wireless manner. The interface 180 can be configured using at least one of a communication module, a terminal, a pin, a cable, a port, a circuit, an element and a device.

The power supply 190 can provide power to the autonomous device 260. The power supply 190 can be provided with power from a power source (e.g., a battery) included in the vehicle 10 and supply the power to each unit of the autonomous device 260. The power supply 190 can operate according to a control signal supplied from the main ECU 240. The power supply 190 may include a switched-mode power supply (SMPS).

The processor 170 can be electrically connected to the memory 140, the interface 180 and the power supply 190 and exchange signals with these components. The processor 170 can be realized using at least one of application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, and electronic units for executing other functions.

The processor 170 can be operated by power supplied from the power supply 190. The processor 170 can receive data, process the data, generate a signal and provide the signal while power is supplied thereto.

The processor 170 can receive information from other electronic devices included in the vehicle 10 through the interface 180. The processor 170 can provide control signals to other electronic devices in the vehicle 10 through the interface 180.

The autonomous device 260 may include at least one printed circuit board (PCB). The memory 140, the interface 180, the power supply 190 and the processor 170 may be electrically connected to the PCB.

(4) Operation of Autonomous Device

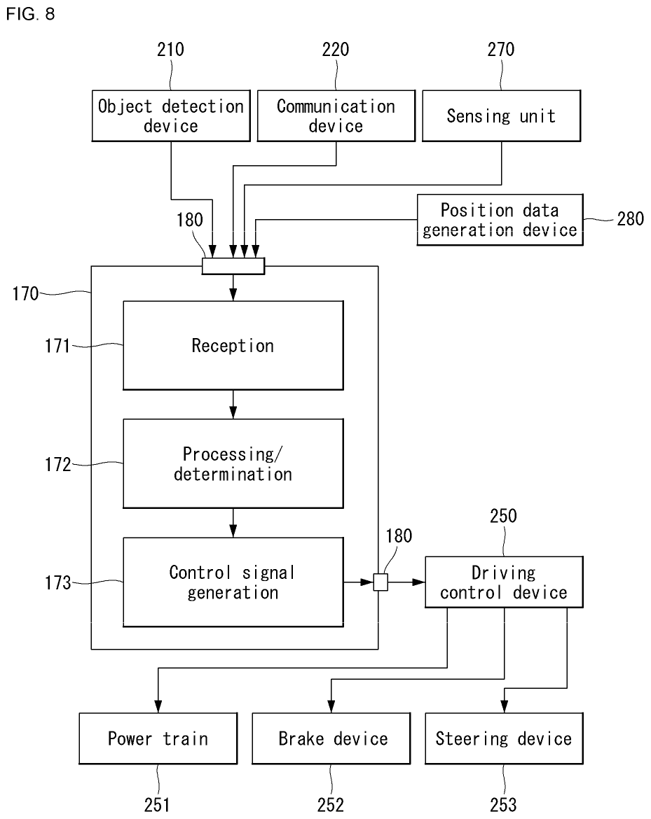

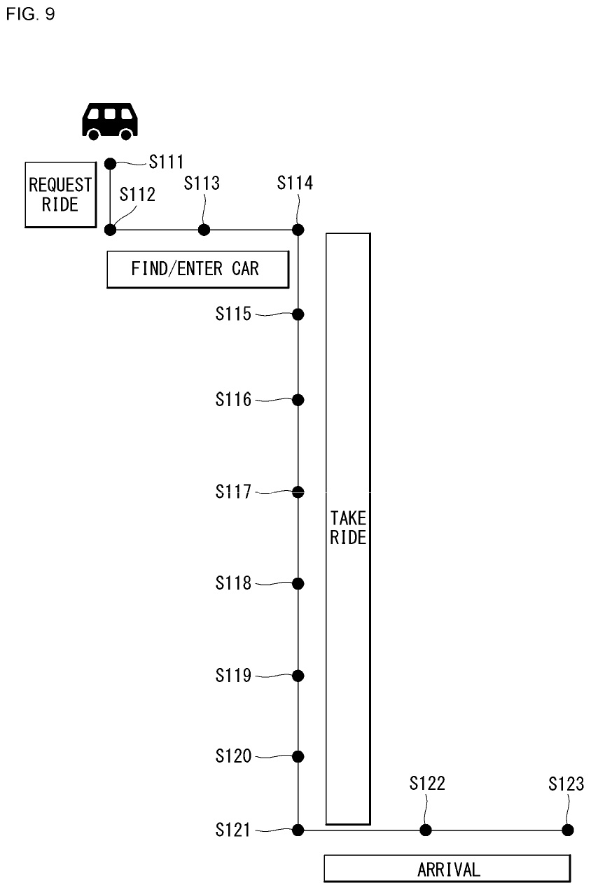

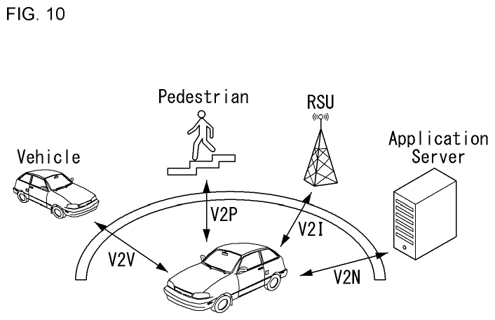

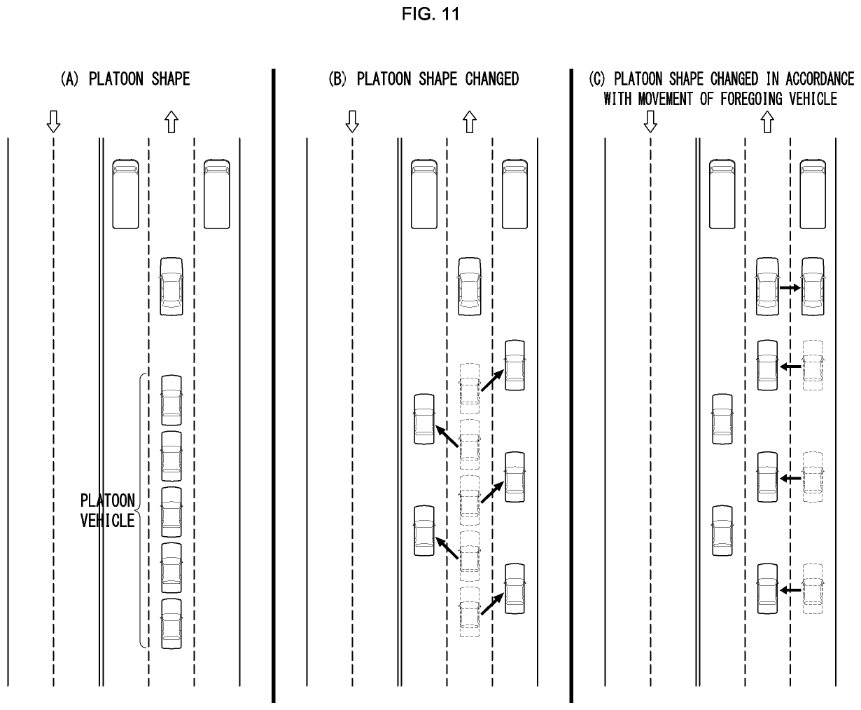

FIG. 8 is a diagram showing a signal flow in an autonomous vehicle according to an embodiment of the present invention.

1) Reception Operation

Referring to FIG. 8, the processor 170 can perform a reception operation. The processor 170 can receive data from at least one of the object detection device 210, the communication device 220, the sensing unit 270 and the position data generation device 280 through the interface 180. The processor 170 can receive object data from the object detection device 210. The processor 170 can receive HD map data from the communication device 220. The processor 170 can receive vehicle state data from the sensing unit 270. The processor 170 can receive position data from the position data generation device 280.

2) Processing/Determination Operation

The processor 170 can perform a processing/determination operation. The processor 170 can perform the processing/determination operation on the basis of traveling situation information. The processor 170 can perform the processing/determination operation on the basis of at least one of object data, HD map data, vehicle state data and position data.

2.1) Driving Plan Data Generation Operation

The processor 170 can generate driving plan data. For example, the processor 170 may generate electronic horizon data. The electronic horizon data can be understood as driving plan data in a range from a position at which the vehicle 10 is located to a horizon. The horizon can be understood as a point a predetermined distance before the position at which the vehicle 10 is located on the basis of a predetermined traveling route. The horizon may refer to a point at which the vehicle can arrive after a predetermined time from the position at which the vehicle 10 is located along a predetermined traveling route.

The electronic horizon data can include horizon map data and horizon path data.

2.1.1) Horizon Map Data

The horizon map data may include at least one of topology data, road data, HD map data and dynamic data. According to an embodiment, the horizon map data may include a plurality of layers. For example, the horizon map data may include a first layer that matches the topology data, a second layer that matches the road data, a third layer that matches the HD map data, and a fourth layer that matches the dynamic data. The horizon map data may further include static object data.

The topology data may be explained as a map created by connecting road centers. The topology data is suitable for approximate display of a location of a vehicle and may have a data form used for navigation for drivers. The topology data may be understood as data about road information other than information on driveways. The topology data may be generated on the basis of data received from an external server through the communication device 220. The topology data may be based on data stored in at least one memory included in the vehicle 10.

The road data may include at least one of road slope data, road curvature data and road speed limit data. The road data may further include no-passing zone data. The road data may be based on data received from an external server through the communication device 220. The road data may be based on data generated in the object detection device 210.

The HD map data may include detailed topology information in units of lanes of roads, connection information of each lane, and feature information for vehicle localization (e.g., traffic signs, lane marking/attribute, road furniture, etc.). The HD map data may be based on data received from an external server through the communication device 220.

The dynamic data may include various types of dynamic information which can be generated on roads. For example, the dynamic data may include construction information, variable speed road information, road condition information, traffic information, moving object information, etc. The dynamic data may be based on data received from an external server through the communication device 220. The dynamic data may be based on data generated in the object detection device 210.

The processor 170 can provide map data in a range from a position at which the vehicle 10 is located to the horizon.

2.1.2) Horizon Path Data

The horizon path data may be explained as a trajectory through which the vehicle 10 can travel in a range from a position at which the vehicle 10 is located to the horizon. The horizon path data may include data indicating a relative probability of selecting a road at a decision point (e.g., a fork, a junction, a crossroad, or the like). The relative probability may be calculated on the basis of a time taken to arrive at a final destination. For example, if a time taken to arrive at a final destination is shorter when a first road is selected at a decision point than that when a second road is selected, a probability of selecting the first road can be calculated to be higher than a probability of selecting the second road.

The horizon path data can include a main path and a sub-path. The main path may be understood as a trajectory obtained by connecting roads having a high relative probability of being selected. The sub-path can be branched from at least one decision point on the main path. The sub-path may be understood as a trajectory obtained by connecting at least one road having a low relative probability of being selected at at least one decision point on the main path.

3) Control Signal Generation Operation

The processor 170 can perform a control signal generation operation. The processor 170 can generate a control signal on the basis of the electronic horizon data. For example, the processor 170 may generate at least one of a power train control signal, a brake device control signal and a steering device control signal on the basis of the electronic horizon data.

The processor 170 can transmit the generated control signal to the driving control device 250 through the interface 180. The driving control device 250 can transmit the control signal to at least one of a power train 251, a brake device 252 and a steering device 254.

(2) Autonomous Vehicle Usage Scenarios

FIG. 11 is a diagram referred to in description of a usage scenario of a user according to an embodiment of the present invention.

1) Destination Prediction Scenario

A first scenario S111 is a scenario for prediction of a destination of a user. An application which can operate in connection with the cabin system 300 can be installed in a user terminal. The user terminal can predict a destination of a user on the basis of user's contextual information through the application. The user terminal can provide information on unoccupied seats in the cabin through the application.

2) Cabin Interior Layout Preparation Scenario

A second scenario S112 is a cabin interior layout preparation scenario. The cabin system 300 may further include a scanning device for acquiring data about a user located outside the vehicle. The scanning device can scan a user to acquire body data and baggage data of the user. The body data and baggage data of the user can be used to set a layout. The body data of the user can be used for user authentication. The scanning device may include at least one image sensor. The image sensor can acquire a user image using light of the visible band or infrared band.

The seat system 360 can set a cabin interior layout on the basis of at least one of the body data and baggage data of the user. For example, the seat system 360 may provide a baggage compartment or a car seat installation space.

3) User Welcome Scenario

A third scenario S113 is a user welcome scenario. The cabin system 300 may further include at least one guide light. The guide light can be disposed on the floor of the cabin. When a user riding in the vehicle is detected, the cabin system 300 can turn on the guide light such that the user sits on a predetermined seat among a plurality of seats. For example, the main controller 370 may realize a moving light by sequentially turning on a plurality of light sources over time from an open door to a predetermined user seat.

4) Seat Adjustment Service Scenario

A fourth scenario S114 is a seat adjustment service scenario. The seat system 360 can adjust at least one element of a seat that matches a user on the basis of acquired body information.

5) Personal Content Provision Scenario

A fifth scenario S115 is a personal content provision scenario. The display system 350 can receive user personal data through the input device 310 or the communication device 330. The display system 350 can provide content corresponding to the user personal data.

6) Item Provision Scenario

A sixth scenario S116 is an item provision scenario. The cargo system 355 can receive user data through the input device 310 or the communication device 330. The user data may include user preference data, user destination data, etc. The cargo system 355 can provide items on the basis of the user data.

7) Payment Scenario

A seventh scenario S117 is a payment scenario. The payment system 365 can receive data for price calculation from at least one of the input device 310, the communication device 330 and the cargo system 355. The payment system 365 can calculate a price for use of the vehicle by the user on the basis of the received data. The payment system 365 can request payment of the calculated price from the user (e.g., a mobile terminal of the user).

8) Display System Control Scenario of User

An eighth scenario S118 is a display system control scenario of a user. The input device 310 can receive a user input having at least one form and convert the user input into an electrical signal. The display system 350 can control displayed content on the basis of the electrical signal.

9) AI Agent Scenario

A ninth scenario S119 is a multi-channel artificial intelligence (AI) agent scenario for a plurality of users. The AI agent 372 can discriminate user inputs from a plurality of users. The AI agent 372 can control at least one of the display system 350, the cargo system 355, the seat system 360 and the payment system 365 on the basis of electrical signals obtained by converting user inputs from a plurality of users.

10) Multimedia Content Provision Scenario for Multiple Users

A tenth scenario S120 is a multimedia content provision scenario for a plurality of users. The display system 350 can provide content that can be viewed by all users together. In this case, the display system 350 can individually provide the same sound to a plurality of users through speakers provided for respective seats. The display system 350 can provide content that can be individually viewed by a plurality of users. In this case, the display system 350 can provide individual sound through a speaker provided for each seat.

11) User Safety Secure Scenario

An eleventh scenario S121 is a user safety secure scenario. When information on an object around the vehicle which threatens a user is acquired, the main controller 370 can control an alarm with respect to the object around the vehicle to be output through the display system 350.

12) Personal Belongings Loss Prevention Scenario

A twelfth scenario S122 is a user's belongings loss prevention scenario. The main controller 370 can acquire data about user's belongings through the input device 310. The main controller 370 can acquire user motion data through the input device 310. The main controller 370 can determine whether the user exits the vehicle leaving the belongings in the vehicle on the basis of the data about the belongings and the motion data. The main controller 370 can control an alarm with respect to the belongings to be output through the display system 350.

13) Alighting Report Scenario

A thirteenth scenario S123 is an alighting report scenario. The main controller 370 can receive alighting data of a user through the input device 310. After the user exits the vehicle, the main controller 370 can provide report data according to alighting to a mobile terminal of the user through the communication device 330. The report data can include data about a total charge for using the vehicle 10.

The above-describe 5G communication technology can be combined with methods proposed in the present invention which will be described later and applied or can complement the methods

The platoon ma proposed in the present invention to make technical features of the present invention concrete and clear.

Platooning means an operation in which at least two or more vehicles are connected on the basis of a wireless communication network and travel and follow a leading vehicle (e.g., a platoon master). The vehicles following the leading vehicle in platooning can save fuel by a slip stream effect in which the vehicles are less influenced by air resistance. Further, the exhaust amount of carbon dioxide can be reduced and the space of a road can be efficiently used, so there is an effect that it is possible to reduce traffic congestion.

In platooning, a plurality of continuous vehicles travels at close distances through vehicle gap control. Vehicle gaps can be maintained by exchanging movements of vehicles in a platoon and latent abnormal situation information through inter-vehicle communication and correspondingly performing control. Further, in platooning, several vehicles in a platoon can simultaneously perform accelerating, braking, passing operations, etc.

In platooning, another vehicle can change a lane and cut into the movement route of platoon vehicles, so the platoon vehicles can serve to perform defense so that another vehicle cannot change a lane in order to secure the traveling route of each of the platoon vehicles.

Further, if the speed of the forward vehicles ahead of platoon vehicles is low, a problem in which the vehicles fail to arrive at a destination within a target time, so the platoon vehicles may attempt passing. In this case, when an abnormal situation such as another vehicle cutting into the platoon occurs, some of the vehicles may fail to pass and an accident may occur.

According, the present specification proposes a method of performing passing after changing the shape of a platoon when several vehicles in a platoon perform a passing operation in platooning, and of generating a new shape of platoon to be suitable for a traffic situation.

When it is required to pass a foregoing vehicle in platooning, all the vehicles in the platoon can perform a passing operation. Alternatively, it may be possible to divide a platoon into sub-platoons and attempt passing in the unit of the sub-platoons. The number of vehicles that attempt passing (e.g., the number of platoon vehicles, the number of sub-platoon vehicles) may be based on a movement speed of a moving object (e.g., a motor cycle) sensed by one of more vehicles of vehicles in platooning lines. For example, the higher the speed of a moving object, the more the vehicles to be grouped in platooning may be. Further, the safety distance may be changed in accordance with the movement speed of the moving object. Further, the longitudinal gaps of in-platoon vehicles that perform passing can be maintained to be smaller than the size of a rearward approaching object. Accordingly, it is possible to prevent a rear approaching object from cutting into the platoon.

In platooning, one platoon may include several vehicles and one platoon may be composed of several sub-platoons. In one platoon, a vehicle that controls several in-platoon vehicles may exist and is referred to as a platoon master for the convenience of description. The other in-platoon vehicles are referred to as platoon slaves. Further, a sub-platoon may be composed of a sub-platoon master and a sub-platoon slave.

FIG. 11 shows an example of a platoon shape in platooning. FIG. 11 is just one example for describing the present disclosure and does not limit the range of the present disclosure. Referring to FIG. 11(a), several vehicles in a platoon may be disposed in a line with a leading vehicle (e.g., a platoon master) at the front. Referring to FIG. 11(b), the platoon shape may be arranged in a zigzag shape in preparation for a situation in which another vehicle suddenly enters the platoon. This shape can prevent a collision that may occur due to another vehicle suddenly cutting into the platoon line. Referring to FIG. 11(c), there is an example in which as the foregoing vehicle ahead of the platoon changes the lane, some following vehicles in the platoon change the lanes. As described above, the shape of a platoon can be changed in accordance with traveling of surrounding vehicles.

Hereafter, a platoon is configured in the configuration described above in the present specification, and a method of performing a passing operation is described under the assumption of the state disposed in the shape of FIG. 11(a). However, this is only for the convenience of description and does not limit the spirit of the present disclosure.

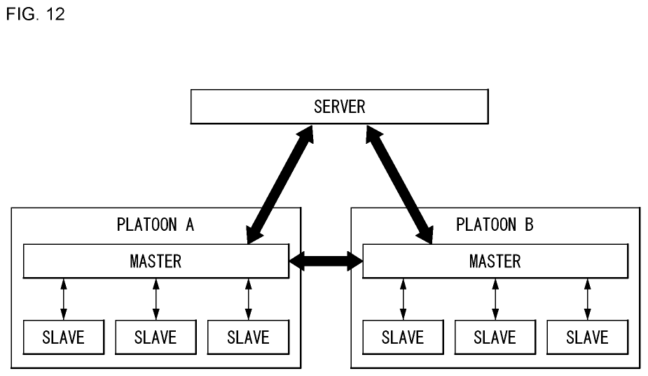

FIG. 12 is an example of a configuration view of a server and platoons of vehicles that perform platooning according to an embodiment proposed in the present disclosure. FIG. 12 is only for the convenience of description and does not limit the range of the present disclosure. Referring to FIG. 12, several vehicles can perform platooning. One platoon may be composed of a master vehicle and a slave vehicle. The master of a platoon can communicate with a server of an autonomous driving system. Further, the master of a platoon can directly communicate with the master of another platoon. Alternatively, it may be possible to communicate with the mater of another platoon through a server. A slave vehicle can communicate with its master vehicle. A slave vehicle can communicate with another slave vehicle, a server, etc. through the master vehicle. Alternatively, direct communication may be possible between slave vehicles in one platoon. In this case, a communication method such as V2X, wireless communication, and side link may be used for the above communication.

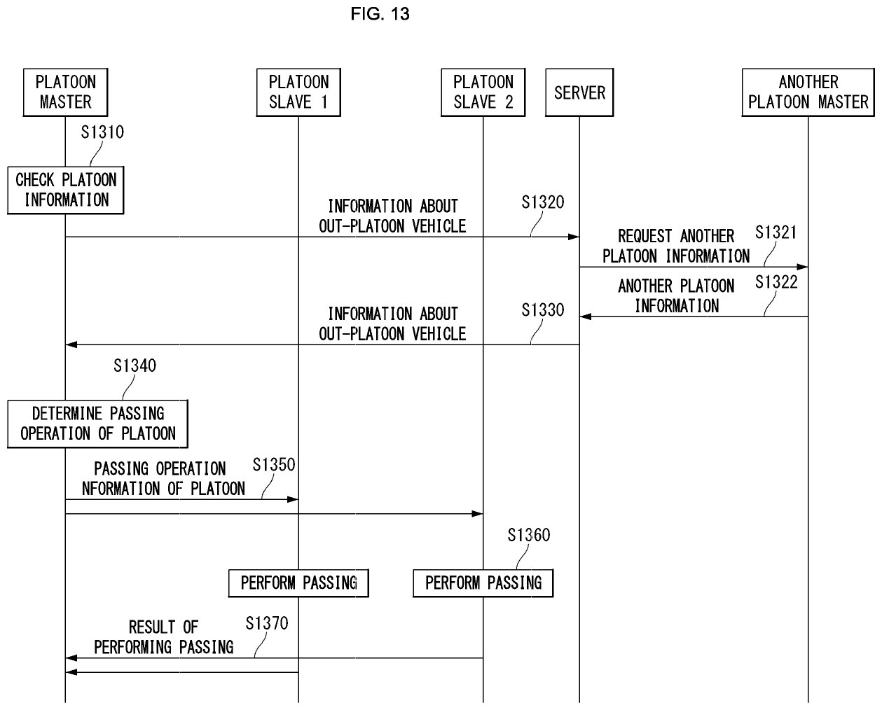

FIG. 13 is a flowchart about a method of performing a passing operation in platooning according to an embodiment proposed in the present disclosure. FIG. 13 is only for describing the present disclosure and does not limit the range of the present disclosure.

In order to perform passing in platooning, a platoon master can check platoon information (S1310). The platoon information may include information such as information about several vehicles constituting the platoon (e.g., the number of vehicles and a platoon disposition shape), a destination, a target arrival time, a predicted arrival time when traveling at the current speed.

Before attempting passing, it is required to check the situation around the platoon, so the platoon master can request information about out-platoon vehicles from a server (S1320). The server may be a server that controls an autonomous driving system. The out-platoon vehicles may include a vehicle position ahead of the platoon and a vehicle in the opposite lane. Further, the out-platoon vehicles may be autonomous vehicles or common vehicles. The information about the out-platoon vehicles may include information such as the locations, speeds, and lanes of the out-platoon vehicles.

The server receiving the request from the platoon master can request another platoon information from another platoon master (S1321) and can receive information of the platoon from the another platoon master (S1322). Steps S1321 and S1322 may be omitted, depending on cases.

The platoon master can receive information about out-platoon vehicles from the server in response to the request (S1330). Further, the platoon master may receive a route to the destination reset in consideration of the degree of traffic congestion from the server. When the steps S1321 and S1322 are omitted, the server can transmit information about another platoon stored before.

The information about the out-platoon vehicles may include information such as the locations, speeds, and lanes of the out-platoon vehicles. In detail, it may include route information of a foregoing vehicle, road situation information ahead of a foregoing vehicle (e.g., disposition of vehicles around the platoon, lanes, and speed), vehicle information of a blind spot in the traveling lane (e.g., a curved road), etc.

The platoon master can determine a passing operation of the platoon on the basis of the information about the out-platoon vehicles and the platoon information (S1340).

For example, the platoon master can check the number of vehicles pertaining to the platoon and the current disposition shape of the platoon on the basis of the platoon information. Further, it is possible to check the number of empty lanes that are available for lane change in a passing operation on the basis of the information about the out-platoon vehicles. In detail, the platoon master can check the number of empty lanes at the left and right sides of a foregoing vehicle by receiving information about how many lanes of several lanes at the left and right sides of the forward vehicle and how many seconds the lanes can be occupied from the server. Further, it is possible to check whether several routes, which allow the vehicles of the platoon can enter parallel positions at the left and right sides of the foregoing vehicle are secured.

The platoon master can check whether all the vehicles of the platoon can change lanes at a time while keeping the current platoon shape by receiving the situation information of a road (e.g., the current vehicle occupation situation for each lane and each time band) from the server when starting a passing operation.

The platoon master can determine how many lanes they will occupy and can calculate how many vehicles can be disposed in each lane on the basis of the information about the out-platoon vehicles and the platoon information. When several lanes are empty, it is possible to determine that several vehicles simultaneously change the lanes to the empty lanes. When the number of empty lanes is smaller than the number of the vehicles of the platoon, it may be possible to the vehicles change to the same lane in a line when changing lanes or the vehicles occupy one or a small number of lanes. Further, the platoon master can determine whether all the in-platoon vehicles can change a lane at a time while maintaining the current platoon. Further, the platoon master can determine how many vehicles can safely pass within an invisible curved section. Further, it is possible to determine routes on which vehicle can travel ahead of the foregoing vehicle after passing the foregoing vehicle in routes.

Meanwhile, it is required to predetermine one or more lanes for safe return when passing a foregoing vehicle in the platoon formation is attempted but fails. The platoon master can check the road situation of the front area of the foregoing vehicle and how many vehicle can pass at a time from the server before performing a passing operation. In preparation for a case in which a passing operation is attempted but fails, it is possible to secure lanes and spaces corresponding to the number of failure vehicles. For example, it is possible to primarily secure a space in a passing-attempt lane as much as the number of passing-failure vehicles. Further, (when a space is not secured in the passing-attempt lane), it is possible to secure a space in an available route (e.g., left and right lanes) in the lane corresponding to a passing route as much as the number of passing-failure vehicles. Hereafter, spare lanes and spaces predetermined in preparation for failure of passing as described above are referred to return preparation lanes in the specification.

The return preparation lane may be one lane or may be several lanes. Further, the return preparation lane may be a lane the same as or different from the platooning lane.

When a passing route is set, but a common vehicle cuts into the front area of a foregoing vehicle and a space where the number of passing-attempt vehicles can be disposed is not secured, it is necessarily required to designate a return preparation lane. Further, when a passing route is set as an opposite lane but a common vehicle approaches in the opposite lane, it is necessarily required to designate a return preparation lane.

The platoon master can transmit passing operation information of the platoon to the platoon vehicles (e.g., platoon slaves) (S1350). The transmission may be performed using V2X.

The passing operation information may include information which lane a vehicle uses when passing, how many vehicles can simultaneously pass in one lane, how many vehicles can pass in a curved section, and a return preparation lane.

The platoon vehicle can perform passing on the basis of the passing operation information of the platoon (S1360) and can transmit the passing result to the platoon master (S1370).

When the passing operation is started, the vehicles of the platoon can change a lane. When changing a lane, it is possible to change a lane in the unit of a vehicle (e.g., platoon slave). Alternatively, it may be possible to change a lane in the unit of a lower sub-platoon of the platoon and the vehicles of the sub-platoon that have changed a lane first may move ahead of the foregoing vehicle.

When changing a lane, the platoon master (e.g., the leading vehicle of the platoon) can perform monitoring on an intended change lane using at least one device of a vehicle. For example, the at least one device of a vehicle may include an object detection device 210 or a sensing unit 270. It is possible to monitor whether another vehicle (e.g., common vehicle) suddenly shows up in an intended change lane (lane that is used for a passing operation) using a sensor and a camera of a vehicle. When another vehicle shows up in the lane that is used for a passing operation after the passing operation is started, the platoon master can inform the platoon vehicles how many vehicles has succeeded in the passing operation in the platoon and which lanes the other vehicles have to move to in order to avoid a collision with another vehicle.

As a detailed example, when changing a lane to the opposite lane for passing, it is required to change the lane to the traveling direction lane before colliding with an opposite vehicle. Accordingly, before changing a lane, the platoon master (e.g., the leading vehicle of the platoon) can estimate whether it is possible to occupy the opposite lane for time that will be taken until a passing operation is finished, on the basis of data acquired using a lidar, a radar, a camera, etc., and can perform a passing operation after changing to the opposite lane only when that is possible. When changing a lane to the opposite lane, the platoon master can receive the location and speed information of a vehicle entering in the opposite side from the server, and the leading vehicle (e.g., the platoon master) of the platoon can transmit a V2X message informing the in-platoon vehicles of a lane change after checking that a vehicle does not approach in the opposite lane through a sensor and a camera so that the vehicles increase the speed and change a lane and then return to the original traveling direction lane after succeeding in passing.

Further, in order that a platoon uses a lane of the opposite traveling direction when passing a foregoing vehicle in a first lane, it can request to vehicles in the opposite lane not to pass the corresponding section while it performs a passing operation through the server. The vehicles receiving the request can slow down and then accelerate after all of the passing vehicles pass.

When the vehicles of the platoon that have changed to the opposite lane to return to the original traveling direction lane, they need to increase the speed not to collide with the foregoing vehicle. When attempting to pass by changing a lane to the opposite lane and another vehicle enters the corresponding lane, it is possible to change back to the traveling direction lane before the approaching vehicle and the vehicles of the platoon that has changed a lane collide. If when not all the in-platoon vehicles fail in passing, it is possible to move to an empty lane in the same direction and attempt to pass again by increasing the speed.

As another example, when passing is performed on a curved road, the leading vehicle of a platoon can check the situation on the traveling direction road and the situation of the opposite side road through at least one device (e.g., a sensor and a camera) of the vehicle. For example, the at least one device of a vehicle may include an object detection device 210 or a sensing unit 270. Further, the platoon master can receive vehicle information (e.g., a lane, whether there is a vehicle, a vehicle speed, a vehicle location, and an intended lane occupation time) in an invisible area (due to a bending of a road) of a curved road from the server. Further, vehicles in an adjacent platoon measure information of an initially showing-up area in a bending section of a road through a sensor and transmit the information to the master, and the master can request the corresponding entering vehicle to delay entry through V2X.

When the shape of a platoon can be maintained even after the platoon passes because the gap from the foregoing vehicle is large in a curved road, it is possible to move to the previous lane or a newly designated lane while maintaining the same platoon shape ahead of the foregoing vehicle by increasing the speed after changing a lane. When the gap from the foregoing vehicle is not sufficiently large, the platoon master can change the shape of the platoon in consideration of the number of lanes, which the platoon can occupy, without maintaining the platoon the same as the previous one ahead of the foregoing vehicle.

As another example, when the foregoing vehicle changes a lane to the opposite side or to the lane in which the platoon moves while moving to a next lane for passing, it is possible to sufficiently increase the distance between the in-platoon vehicles so that a collision with the corresponding vehicle in the platoon. When passing a foregoing vehicle while platooning at a crossroad of a road, the vehicles of the platoon can change into a platoon shape that can pass the crossroad before a signal lamp is changed while the green light of the signal lamp is turned on, can pass the foregoing vehicle, and then can change into a platoon for long-distance traveling while returning to the previous lane.

Further, when failing in passing, it is possible to return to the previous lane, and in this case, when another vehicle occupies the corresponding lane, it is possible to evade to a return preparation lane. The return preparation lane means a lane that the platoon master has predetermined for preparation in preparation for failure of passing. The return preparation lane may be one or more, and it is possible to evade to several return preparation lanes when there are many vehicles that has failed in passing.

In platooning, only some vehicles of the platoon may succeed in passing and the other some vehicles may fail in passing. It is possible to secure a disposition space ahead of the foregoing vehicle by generating a sub-platoon with the vehicles that have succeeded in passing so that the other platoon vehicles can pass. A sub-platoon master can request the server that out-platoon vehicles leave the corresponding lane empty. Alternatively, in order to secure a vehicle disposition space of the entire platoon in the space ahead of the foregoing vehicle, the vehicles of the sub-platoon that have succeeded in passing occupy the lane first, thereby being able to prevent entry of another vehicle. In this case, signal transmission and reception among the platoon vehicles, the server, and another vehicle can be achieved through V2X.

Alternatively, the vehicles that have failed in passing may form a sub-platoon. The sub-platoon that has failed in passing moves to a return preparation lane and the sub-platoon master can check an empty lane of the left and right lanes of the foregoing vehicle. In this case, it is possible to receive forward situation information of the foregoing vehicle from the server. On the basis of the information, it is possible to determine passing-available section, time, etc. and transmit a passing traveling instruction, and then, it is possible to reattempt passing through a spare lane.

It is possible to generate a new shape of platoon with the vehicles that have succeeded in passing in order to be able to arrive at a destination within a determined time. In this case, the traveling route and the traffic (congestion) of a road can be considered.

For example, it is possible to form a platoon on the basis of the point in time of departing from the platoon. A vehicle having the farthest distance to a destination finally departs from the platoon, so vehicles having far distances to the destination can be disposed at the front of the platoon. A vehicle that early departs from the platoon is disposed at the rear or the side of the platoon, thereby being able to prevent deformation of the entire platoon when the vehicle departs from the platoon.

As another example, it is possible to forma platoon on the basis of the capability of vehicles. The capability of a vehicle may correspond to the devices in the vehicle such as a sensor and a camera. For example, a vehicle equipped with a long-distance radar may be disposed at the front of a platoon. Further, a vehicle equipped with a short-distance lidar may be disposed at a side adjacent to other vehicles.

When there is a plurality of passing routes, the above method can be applied. In-platoon vehicles may perform passing in several divided sub-platoons. The location of a platoon can be set by vehicles of sub-platoons that have succeeded in passing ahead of a foregoing vehicle.

For example, in consideration of the distances to destinations of vehicles of sub-platoons that have succeeded in passing, it is possible to form a platoon in a new shape by disposing vehicles that have to move a long distance because the destinations are far at the front and disposing vehicles that will depart in the middle at the rear. Further, as for vehicles of which the distances to destinations are the same, it is possible to dispose vehicles having high capability at a position (e.g., a side and a sidewalk side) where they meet a vehicle adjacent to the head of the platoon in consideration of the capability of each vehicle (e.g., whether a long-distance radar and a short-range lidar are mounted). The position of each vehicle in the new shape of platoon can be designated on the basis of specific references (e.g., order of distance far from a destination and disposition according to sensor ability) by a platoon master.

Vehicles that have succeeded in passing request adjacent vehicle to change a lane through V2X in order to secure a space and a lane that all the other vehicles pertaining to the platoon can enter ahead of a foregoing vehicle, and occupy positions in a lane where a complete shape can be reconstructed when platoons are combined due to a sufficient spare space.

The vehicles that have succeeded in passing request autonomous vehicles, which cut in the middle, not to enter through a V2X message such that a complete platoon shape can be maintained later, and when a common vehicle enters, the in-platoon vehicles occupy a space first in advance by increasing the speed such that the corresponding vehicle cannot enter.

The platoon master can change the platoon into the shape (e.g., straight shape or two lines) of a platoon that is advantageous in traveling to destinations in a changed lane, and can maintain the shape until arriving at the destinations.

It is possible to consider the situation in which a plurality of platoons performs platooning in an autonomous driving system. A platoon that attempts to pass a foregoing vehicle can perform passing through communication with the server of the autonomous driving system, and another platoon.

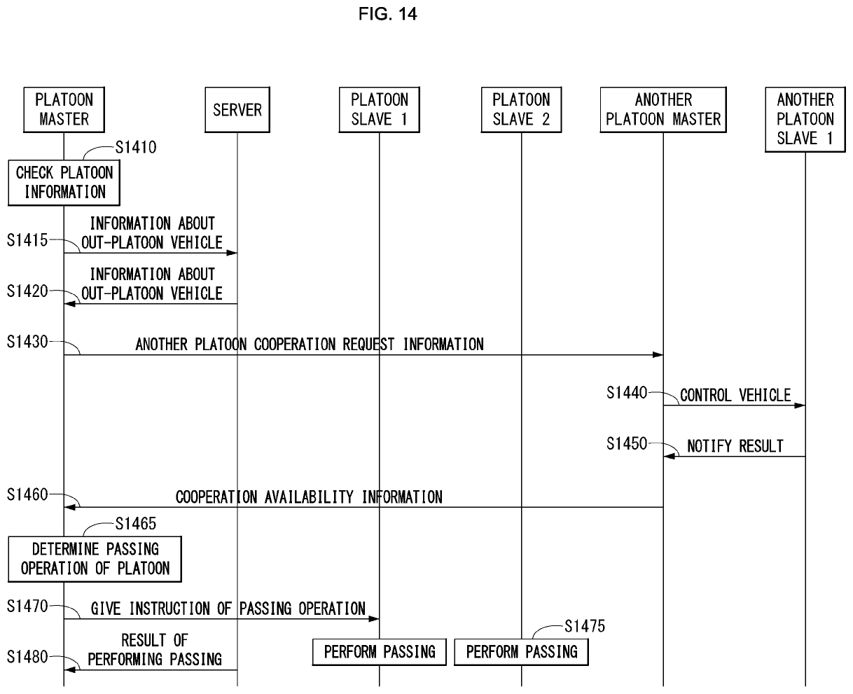

FIG. 14 is a flowchart about a method of performing a passing operation including communication with another platoon in platooning according to an embodiment proposed in the present disclosure. FIG. 14 is only for describing the present disclosure and does not limit the range of the present disclosure.

In order to perform passing in platooning, a platoon master can check platoon information (S1410). The platoon information may include information such as information about several vehicles constituting the platoon (e.g., the number of pieces of vehicles and a platoon disposition shape), a destination, a target arrival time to a destination, a predicted arrival time when traveling at the current speed.

The platoon master can request information about out-platoon vehicles from a server (S1415). The server may be a server that controls an autonomous driving system. The out-platoon vehicles may include a vehicle position ahead of the platoon and a vehicle in the opposite lane. Further, the out-platoon vehicles may be autonomous vehicles or common vehicles. The information about the out-platoon vehicles may include information such as the locations, speeds, and lanes of the out-platoon vehicles.

The platoon master can receive information about out-platoon vehicles from the server in response to the request (S1420). Further, the platoon master may receive a route to the destination reset in consideration of the degree of traffic congestion from the server. The information about the out-platoon vehicles may include information such as the locations, speeds, and lanes of the out-platoon vehicles. In detail, it may include route information of a foregoing vehicle, road situation information ahead of a foregoing vehicle (e.g., disposition of vehicles around the platoon, lanes, and speed), vehicle information of a blind spot in the traveling lane, etc.

The platoon master can transmit another platoon cooperation request information to another platoon master on the basis of the information about the out-platoon vehicles (S1430). The another platoon cooperation request information may be transmitted to the another platoon master through a server.

For example, the another platoon cooperation request information may include information of the number of lanes required for changing a lane, a lane occupation time, the number and speed of platoon vehicles, etc. Further, it may be possible to request permission to pass to another platoon. In order that a platoon uses a lane of the opposite traveling direction when passing a foregoing vehicle in a first lane, it can request to vehicles in the opposite lane not to pass the corresponding section while it performs a passing operation.

The another platoon master can transmit information (e.g., a lane that has to be empty, an empty state time, and speed) for controlling its slave vehicle to the slave vehicle on the basis of the received information (S1440). The another platoon slave changes a lane in accordance with the control information and then can transmit the result to the another platoon master (S1450).

The another platoon master can transmit cooperation availability information to the platoon master that attempts to pass (S1460). The cooperation availability information may include information such as whether or not of lane occupation permission, an available lane, an available occupation time. Another platoon master in the opposite lane and/or at the front area can inform the platoon master of the cooperation availability information in consideration of its destination arrival time.

The platoon master can determine a passing operation of the platoon on the basis of the information about the out-platoon vehicles, the platoon information, and the cooperation availability information (S1465).

For example, the platoon master can calculate how many lanes vehicles will occupy and how many vehicles can be disposed in each lane. When several lanes are empty, it is possible to determine that several vehicles simultaneously change the lanes to the empty lanes. When the number of empty lanes is smaller than the number of the vehicles of the platoon, it may be possible to the vehicles change to the same lane in a line when changing lanes or the vehicles occupy one or a small number of lanes. Further, the platoon master can determine whether all the in-platoon vehicles can change a lane at a time while maintaining the current platoon. Further, the platoon master can determine how many vehicles can safely pass within an invisible curved section. Further, it is possible to determine routes on which vehicle can travel ahead of the foregoing vehicle after passing the foregoing vehicle in routes.

ster can instruct the platoon slave to perform a passing operation (S1470). The instruction may be performed using V2X.

The platoon vehicle can perform passing on the basis of the passing operation information of the platoon (S1475) and can transmit the passing result to the platoon master (S1480). The platoon master can attempt to pass by controlling a lane change and a speed for the in-platoon vehicles.

When the passing operation is started, the vehicles of the platoon can change a lane. When failing in passing, it is possible to return to the previous lane, and in this case, when another vehicle occupies the corresponding lane, it is possible to evade to a return preparation lane. Further, the platoon master can generate a new shape of platoon with the vehicles that have succeeded in passing in order to be able to arrive at a destination within a determined time. In this case, the traveling route and the traffic (congestion) of a road can be considered.

Steps S1475 and S1480 may correspond to steps S1360 and S1370 described above. According, repeated description is omitted below.

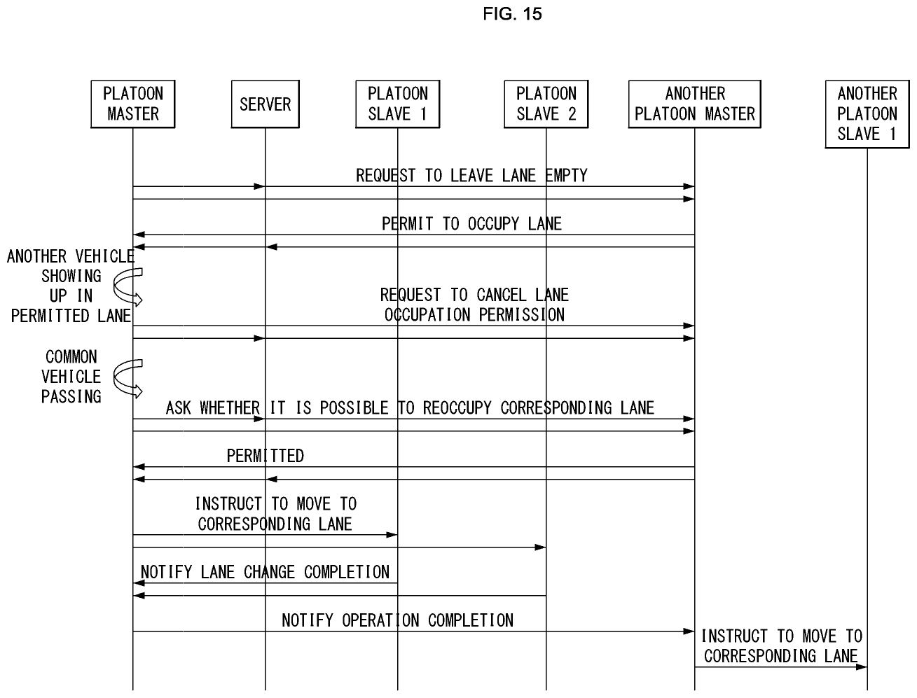

FIG. 15 is a flowchart related to passing-reattempt when passing is attempted but fails in platooning according to an embodiment proposed in the present disclosure. FIG. 15 is only for describing the present disclosure and does not limit the range of the present disclosure.

A platoon master can request another platoon master in the lane that will be used for a passing operation to leave the lane empty. The lane that will be used for a passing operation may include an opposite side lane or a curved road. The another platoon master can find out the traveling situation of vehicles in its platoon and inform the platoon master of whether or not of lane occupation permission. When another vehicle enters the permitted lane before a passing operation is started, the platoon master can request the another platoon master to cancel the passing permission for the lane permitted before. When the another vehicle leaves, the platoon master can ask the another platoon master whether it is possible to reoccupy the lane as a passing lane. When the another platoon master permits again occupation of the lane, the platoon master can instruct it slave vehicle to change a lane and pass. The platoon slave vehicle can return to the previous traveling lane after succeeding in passing. Further, it can transmit the passing result to the platoon master. The platoon master can notify the another platoon master that lane occupation has been finished, and the another platoon master can inform its slave vehicle that passing has been finished and the lane is not available.

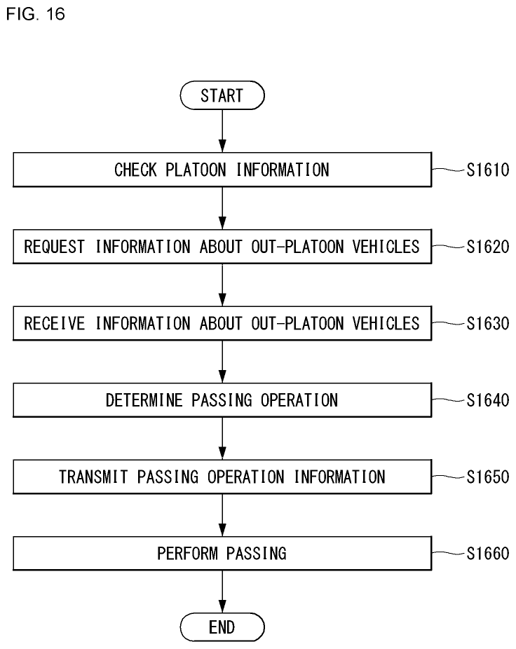

FIG. 16 shows an example of an operation flowchart of a vehicle to which the method and embodiment described above can be applied.

In FIG. 16, it is assumed that the vehicle performs platooning in an autonomous driving system. In platooning, one platoon may include several vehicles and one platoon may be composed of several sub-platoons. A vehicle that controls several vehicles in one platoon may exist in the platoon, in which it is assumed that the vehicle is a first vehicle (e.g., platoon master) and the other in-platoon vehicles are second vehicles. The operation of the first vehicle may correspond to the operation of the platoon master in FIGS. 13 to 15.

Referring to FIG. 16, several vehicles constituting a platoon may include a first vehicle that controls platooning and a second vehicle that is controlled by the first vehicle. In order that several vehicles that perform platooning pass a target vehicle, the first vehicle can check information of the platoon (S1610). The information of the platoon may include at least one of the number of vehicles constituting the several vehicles, the shape of the platoon, a destination, a target arrival time, and a predicted arrival time. The shape of the platoon can be deformed in accordance with the number of lanes to be used for passing, the speed of the target vehicle, and the gap between the platoon and the target vehicle.

The first vehicle can request information about out-platoon vehicles from a server (S1620). The first vehicle can receive the information about the out-platoon vehicles from the server (S1630). The information about the out-platoon vehicles may include at least one of items of information such as the locations, speeds, and lanes of the out-platoon vehicles. The first vehicle and the server can communicate through V2X.

The first vehicle can determine a passing operation of the platoon on the basis of the platoon information and the information about the out-platoon vehicles (S1640). The step of determining a passing operation may include securing a preparation lane in preparation for the case in which passing fails. When an out-platoon vehicle enters the preparation lane, the first vehicle can transmit no-entering notification to the out-platoon vehicle through a vehicle network.

The first vehicle can transmit the passing operation information to the second vehicle (S1650). The first vehicle may broadcast information about the lane to be used for passing to the out-platoon vehicles. Further, the first vehicle may receive permission to use and available time for the lane to be used for passing from the out-platoon vehicles.

The several vehicles can pass the target vehicle (S1660). Further, they can be fed back a passing performing result from other vehicles (e.g., the second vehicle).

When performing passing, the entire platoon can perform passing with the shape of the platoon maintained. Alternatively, the platoon may be divided into sub-platoons and some vehicles in the platoon may sequentially perform passing, depending on the traveling situation of the out-platoon vehicles. When some vehicles of the several vehicles fail in passing, the some vehicles that have failed in passing can move to the preparation lane.

Some vehicles that have succeeded in passing in the platoon can perform an operation for helping the vehicles that have failed in passing attempt passing again. For example, some vehicles that have succeeded in passing may form one sub-platoon and the sub-platoon master may control the disposition (shape) of the sub-platoon and speeds of the vehicles in the sub-platoon in order to secure a passing space for the vehicles that have failed in passing.

As a detailed example, when only some vehicles succeed in passing and the platoon is divided due to a change in lines or disposition of out-platoon vehicles, the master of the sub-platoon that has succeeded in passing can secure a passing space for the vehicles that have failed in passing and the vehicles that did not pass on the basis of the changed shape of the out-platoon vehicles. That is, it is possible to reset the traveling location of the sub-platoon that has succeeded in passing so that the vehicles that have failed in passing and the vehicles that did not pass can be positioned in a passing completion route (joint the platoon upon passing). To this end, the speed of the sub-platoon can be set to be lower than the passing speed of the vehicles that did not pass and to be the same as or higher than the speed of the out-platoon vehicles.

If the a passing target that does not satisfy the speed condition shows up, it can be excluded from a passing target. In this case, the sub-platoon master can recalculate the passing route and the point to joint the platoon after passing of the vehicles that did not pass. Alternatively, when all of passing target vehicles disappear (e.g., when the out-platoon vehicle accelerate and leave the passing range), it is possible to reset the passing route.

Further, it is possible to monitor a passing situation using at least one device of the first vehicle. The at least one device of a vehicle may include an object detection device 210 or a sensing unit 270. The device may include a sensor or a camera.

Further, it is possible to form a new shape of platoon with the vehicles that have succeeded in passing. The new shape may be formed on the basis of the point in time of departing from the platoon. Alternatively, the new shape may be formed on the basis of the capability of vehicles. The new shape of the platoon can be transmitted to the second vehicle.

Hereafter, embodiments to which the method proposed in the present disclosure can be applied are described in detail. Embodiments to be described hereafter are only examples for describing the present disclosure and do not limit the range of the present disclosure.

In the following embodiments, a vehicle exists at the front of platooning vehicles and is referred to a foregoing vehicle. Further, other vehicles may exist ahead of the foregoing vehicle and they are referred to as a forward vehicle 1 and a forward vehicle 2. For the convenience of description, it is assumed that there is one foregoing vehicle and two forward vehicles. Further, it is assumed that one platoon is composed of several vehicles. However, these assumptions do not limit the spirit of the present disclosure. Accordingly, it is apparent that the assumptions can be applied even if vehicles more than the number of the assumed vehicles exist at the front of the platooning vehicles.

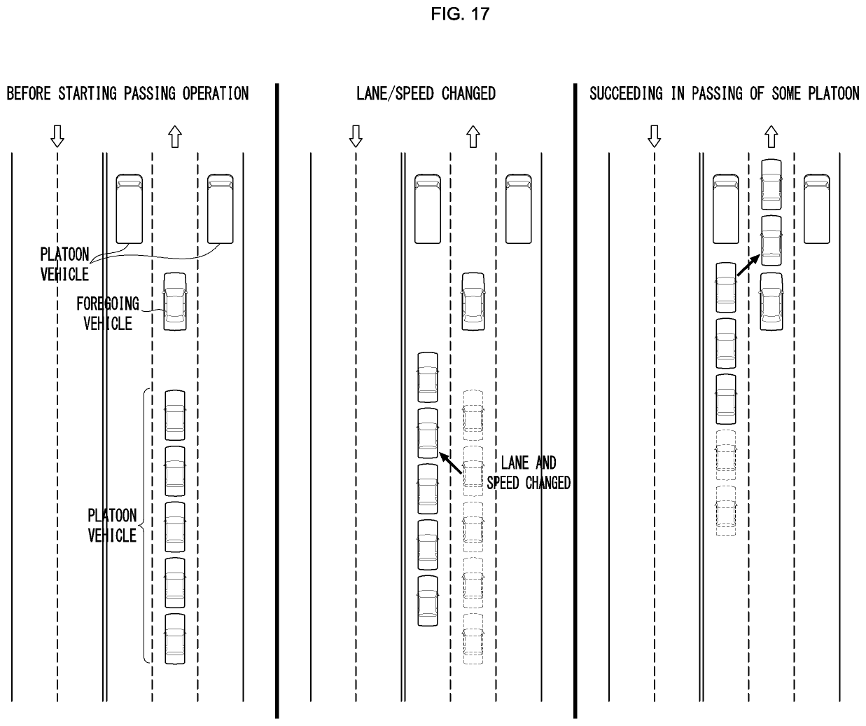

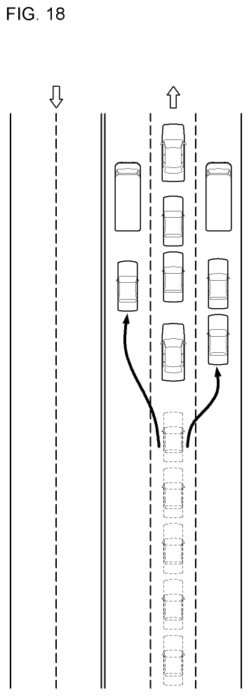

FIG. 17 is an example of a passing operation in platooning. It is assumed in FIG. 17 that there are several upward lanes and downward lanes. Further, it is assumed that the shape of a platoon is a long one line shape.

Referring to FIG. 17, in order to pass a foregoing vehicle while maintaining the shape of a platoon, all the vehicles included in the platoon can change a lane to another lane except for the lane that the foregoing vehicle occupies. It is possible to attempt passing by increasing the speed. In this case, when only some of the platooning vehicles succeed in passing and the other vehicles fail in passing due to the forward vehicle 1 or the forward vehicle 2, the other vehicles can keep traveling at the position where the vehicles that have succeeded in passing was.

FIG. 18 is an example of a passing operation when several passing routes are set. It is also assumed in FIG. 18 that there are several upward lanes and downward lanes. Further, it is assumed that the shape of a platoon is a long one line shape.

Referring to FIG. 18, passing lanes can be set at the left and right sides of the foregoing vehicle ahead of the platoon. In this case, the platoon can be divided into sub-platoons and the sub-platoons can perform passing along assigned routes, respectively. When the platoon vehicles succeed in passing the foregoing vehicle, but fail in passing the forward vehicles, it is possible to change the shape of the platoon and move fast in accordance with the speed of the forward vehicles.

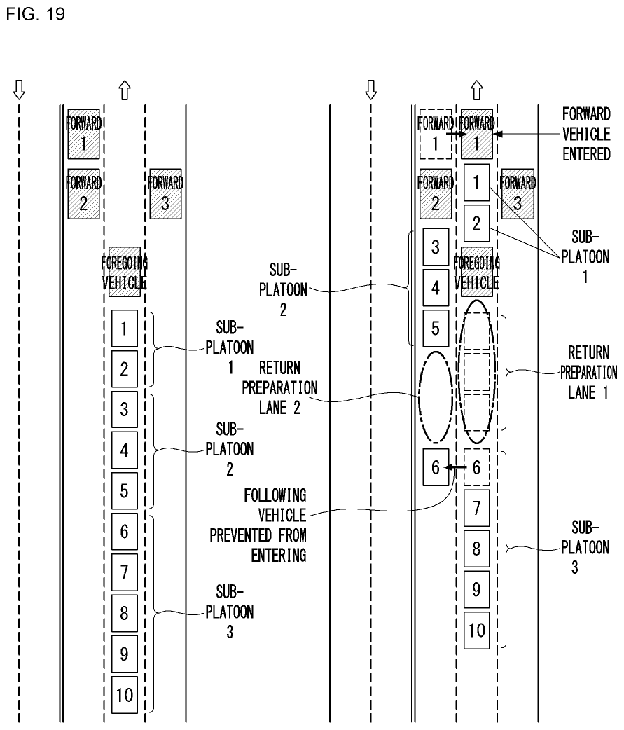

FIG. 19 shows an example of setting a return preparation lane. It is assumed in FIG. 19 that one platoon is composed of three sub-platoons.

Referring to FIG. 19, in platooning, the sub-platoon 1 and the sub-platoon 2 can change a lane to pass the foregoing vehicle. During passing, a vehicle positioned in another line enters, the number of passing-possible vehicles may be limited. A platoon master can find out the number of vehicles that can succeed in passing (sub-platoon 1), the number of vehicles that can change a lane for passing (sub-platoon 2), and the other vehicles (sub-platoon 3) in the platoon.

The vehicles of the sub-platoon 1 and the sub-platoon 2 can change a lane and attempt passing by accelerating. The position where the sub-platoon 1 and the sub-platoon were as a return preparation lane (e.g., return preparation lane 1). When a vehicle in another lane turns on a turn signal to change a lane and enter the return preparation lane, at least one vehicle (e.g., the platoon master) of the platoon vehicles can determine whether the vehicle is an autonomous vehicle or a common vehicle. If the entering vehicle is an autonomous vehicle, it is possible to request the vehicle not to enter the lane through V2X. If the vehicle that is attempting to enter is a common vehicle, a following vehicle in the platoon increases the speed and moves to a corresponding position, thereby being able to prevent the common vehicle from entering.

If another vehicle has already entered the return preparation lane, the platoon master can designate a lane, to which the platoon can move, of surrounding lanes as a new return preparation lane (e.g., a return preparation lane 2) and can share the new return preparation lane information with the platoon vehicles through V2X.

When the vehicles of the sub-platoon 1 succeed in passing, the master of the sub-platoon 1 can transmit the number and the IDs of the vehicles that have succeeded in passing to the platoon mater through V2X. The platoon master can transmit an instruction to remove the space in the return preparation lane as much as the number of the vehicles that have succeeded in passing, and to make other vehicles occupy the corresponding lane.

The platoon master, for a passing operation of the sub-platoon 2, receives information about the forward situation ahead of the foregoing vehicle to be passed from a server, and can check how many vehicles can pass and can request the foregoing vehicle to leave the front area empty. Further, the platoon mater can instruct the vehicles of the sub-platoon 2 to perform a passing operation.

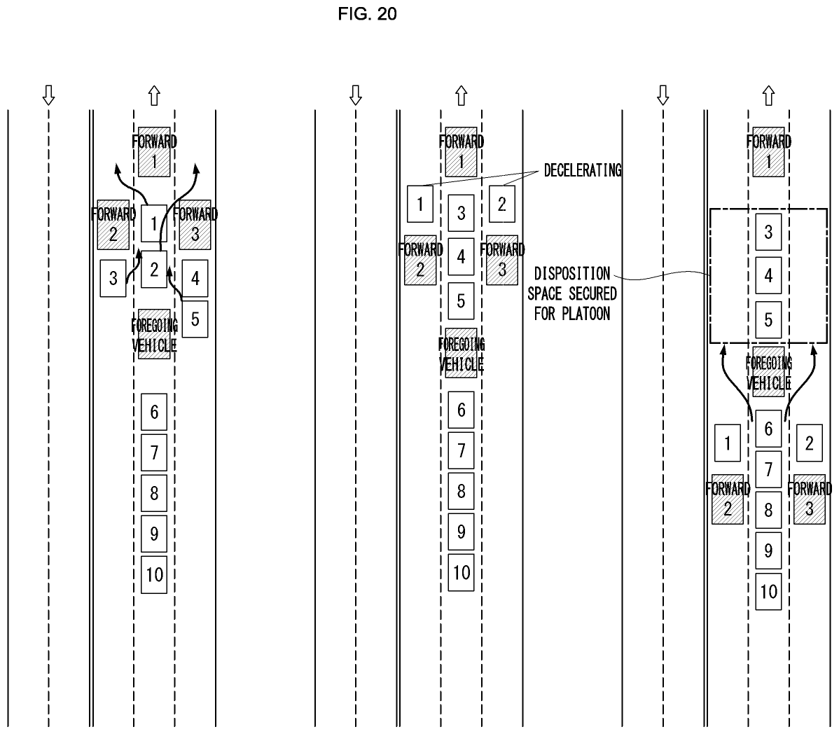

FIG. 20 is an example of securing a disposition space of all platoon vehicles by preventing entry of another vehicle when only some of platooning vehicles succeed in passing.

Referring to FIG. 20, vehicles 1 to 10 can travel while forming one platoon. FIG. 20 exemplifies a situation in which in-platoon vehicles have attempt to pass a foregoing vehicle, but only some vehicles (vehicles 1 to 5) have succeeded in passing and the other vehicles (vehicles 6 to 10) have failed in passing. In this case, the vehicles that have succeeded in passing the foregoing vehicle can perform an operation for helping the vehicles that have failed in passing or the vehicles that did not attempt passing yet to pass.

For example, some vehicles (vehicles 1 and 2) of the vehicles that have succeeded in passing the foregoing vehicle may also succeed in passing forward vehicles (a forward vehicle 2 and a forward vehicle 3). As a result, the vehicles 3, 4, and 5 can pass the foregoing vehicle and move to the positions where the vehicles 1 and 2 were. By disposing in this way, it is possible to prevent the forward vehicles (the forward vehicle 2 and the forward vehicle 3) from increasing the speed. The vehicles (vehicles 1 and 2) that have succeeded in passing even the forward vehicles can secure the lane by decelerating such that the forward vehicles decrease the speed and stay behind. The vehicles that have failed in passing the foregoing vehicle or the vehicles that did not attempt passing yet (vehicles 6 to 10) can pass the foregoing vehicle and the forward vehicles 1 and 2 using the secured lane.

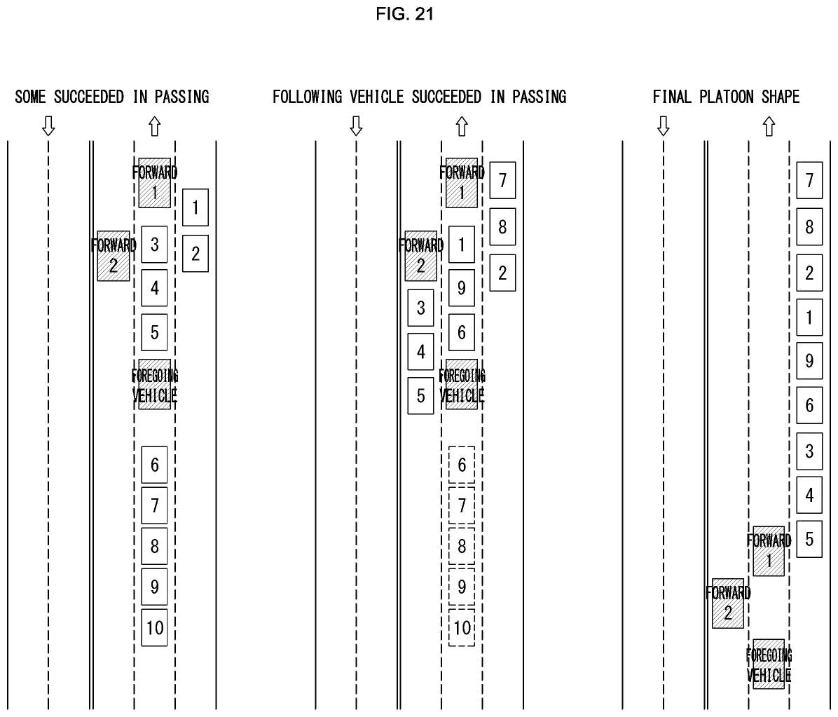

FIG. 21 shows an example when a new platoon shape is formed after passing succeeds.

Referring to FIG. 21, it is possible to newly form the platoon shape of vehicles that have succeeded in passing after succeeded in passing. For example, it is possible to dispose a vehicle having the farthest destination at the front. This is because the farther the vehicle from a destination, the more the vehicle departs from the platoon later, so the possibility that the shape of the platoon is maintained is high. Further, the capacity of a vehicle may be considered. In FIG. 21, the vehicle 7 that is the front vehicle in the final platoon shape corresponds to a vehicle equipped with lidar, radar sensors, etc.

Hereafter, various embodiments of the method of passing another vehicle in platooning in an autonomous driving system according to an embodiment of the present disclosure are described.

### Embodiment 1

A method of controlling several vehicles that perform platooning in an autonomous driving system (Automated Vehicle & Highway Systems), in which the several vehicles constituting a platoon include a first vehicle controlling platooning and a second vehicle controlled by the first vehicle, and the method includes: checking information of the platoon by means of the first vehicle; requesting information about out-platoon vehicles from a server by means of the first vehicle; receiving the information about the output-platoon vehicles from the server by means of the first vehicle; determining a passing operation of the platoon on the basis of the platoon information and the information about the out-platoon vehicles by means of the first vehicle; transmitting information about the passing operation to the second vehicle by means of the first vehicle; and passing a target vehicle by means of the several vehicles.

### Embodiment 2

In Embodiment 1, the information of the platoon may include at least one of the number of vehicles constituting the several vehicles, the shape of the platoon, a destination, a target arrival time, and a predicted arrival time.

### Embodiment 3

In Embodiment 1, the information about the out-platoon vehicles may include at least one of items of information such as locations, speeds, and lanes of the out-platoon vehicles.

### Embodiment 4

In Embodiment 1, the determining of a passing operation may include securing a preparation lane in preparation for the case in which passing fails.

### Embodiment 5

In Embodiment 4, when an out-platoon vehicle enters, the first vehicle may transmit no-entering notification to the out-platoon vehicle through a vehicle network.

### Embodiment 6

In Embodiment 4, when some vehicles of the several vehicles fail in passing, the some vehicles may move to the preparation lane.

### Embodiment 7

In Embodiment 1, the shape of the platoon may be deformed in accordance with the number of lanes to be used for passing, the speed of the target vehicle, and the gap between the platoon and the target vehicle.

### Embodiment 8

In Embodiment 7, the entire platoon may pass the target vehicle while maintaining the shape of the platoon.

### Embodiment 9

In Embodiment 1, it is possible to monitor a passing situation using at least one device of the first vehicle.

### Embodiment 10

In Embodiment 1, the method may further include broadcasting information about a lane to be used for passing to the out-platoon vehicles by means of the first vehicle.

### Embodiment 11

In Embodiment 10, the method may further include receiving permission to use and available time for the lane to be used for passing from the out-platoon vehicles by means of the first vehicle.

### Embodiment 12

In Embodiment 1, the first vehicle and the server may communicate through V2X.

### Embodiment 13

In Embodiment 1, the method may further include forming a new shape of platoon with vehicles that have succeeded in passing.

### Embodiment 14

In Embodiment 13, the new shape may be formed on the basis of the point in time of departing from the platoon.

### Embodiment 15

In Embodiment 13, the new shape may be formed on the basis of capability of a vehicle.

### Embodiment 16

Several vehicles that pass a target vehicle in an autonomous driving system (Automated Vehicle & Highway Systems), the several vehicles perform platooning by constituting a platoon and comprises a first vehicle controlling the platooning and a second vehicle controlled by the first vehicle, in which the first vehicle includes: a communication module; a memory; and a processor, and the processor may check information about the platoon, request information about out-platoon vehicles by controlling the communication module, receive the information about the out-platoon vehicles from the server by controlling the communication module, control the communication module to determine a passing operation of the platoon on the basis of the platoon information and the information about the out-platoon vehicles and to transmit the information about the passing operation to the second vehicle, and control vehicles that perform the platooning to pass the target vehicle.

### Embodiment 17

In Embodiment 16, the first vehicle further includes at least one of a sensor or a camera, and may monitor a situation of performing passing using at least one of the sensor or the camera.

### Embodiment 18

In Embodiment 16, the processor may operate to secure a preparation lane in preparation for a case in which passing fails.

### Embodiment 19

In Embodiment 18, when the out-platoon vehicle enters the preparation lane, no-entering notification may be transmitted to the out-platoon vehicle through a vehicle network by controlling the communication module.

### Embodiment 20

In Embodiment 18, when passing fails, a vehicle may move to the preparation lane.

### Embodiment 21

In Embodiment 16, the information of the platoon may include at least one of the number of vehicles constituting the several vehicles, the shape of the platoon, a destination, a target arrival time, and a predicted arrival time.

### Embodiment 22

In Embodiment 16, the information about the out-platoon vehicles may include at least one of items of information such as locations, speeds, and lanes of the out-platoon vehicles.

### Embodiment 23

In Embodiment 16, information about a lane to be used for passing may be broadcasted to the out-platoon vehicles by controlling the communication module.

### Embodiment 24

In Embodiment 16, the shape of the platoon may be controlled to be deformed in accordance with the number of lanes to be used for passing, the speed of the target vehicle, and the gap between the platoon and the target vehicle.

### Embodiment 25

In Embodiment 24, the passing operation information may include information that instructs the entire platoon to perform passing while maintaining the shape of the platoon.

### Embodiment 26

In Embodiment 16, the processor may form a new shape of platoon with vehicles that have succeeded in passing.

### Embodiment 17

In Embodiment 26, the communication module may be controlled to transmit the new shape of platoon to the second vehicle.

### Embodiment 28

In Embodiment 26, the new shape may be formed on the basis of the point in time of departing from the platoon.

### Embodiment 29

In Embodiment 26, the new shape may be formed on the basis of capability of a vehicle.

### Embodiment 30

In Embodiment 16, a passing result may be received from the second vehicle by controlling the communication module.

The present disclosure can be achieved as computer-readable codes on a program-recoded medium. A computer-readable medium includes all kinds of recording devices that keep data that can be read by a computer system. For example, the computer-readable medium may be an HDD (Hard Disk Drive), an SSD (Solid State Disk), an SDD (Silicon Disk Drive), a ROM, a RAM, a CD-ROM, a magnetic tape, a floppy disk, and an optical data storage, and may also be implemented in a carrier wave type (for example, transmission using the internet). Accordingly, the detailed description should not be construed as being limited in all respects and should be construed as an example. The scope of the present disclosure should be determined by reasonable analysis of the claims and all changes within an equivalent range of the present disclosure is included in the scope of the present disclosure.

Although the present disclosure was described above with reference to embodiments, the embodiments are only examples and do not limit the present disclosure, and those skilled in the art would know that the present disclosure may be changed and modified in various ways not exemplified above without departing from the scope of the present disclosure. For example, the components described in detail in the embodiments of the present disclosure may be modified. Further, differences relating to the changes and modifications should be construed as being included in the scope of the present disclosure which is determined by claims.

According to an embodiment of the present disclosure, in platooning in an autonomous driving system, there in an effect in that it is possible to prevent a collision with another vehicle when changing a lane by safely changing the shape of a platoon when passing a foregoing vehicle, and it is possible to secure safety in vehicle traveling.

Further, according to an embodiment of the present disclosure, it is possible to prevent a collision with other vehicles in the opposite direction and in the forward area when passing a foregoing vehicle by receiving a traffic situation of an invisible road section in advance through a server when traveling on a curved road in an autonomous driving system.

Further, according to an embodiment of the present disclosure, it is possible to arrive at a destination within a target time by forming a new shape of platoon with vehicles that have succeeded in passing.

The effects of the present disclosure are not limited to the effects described above and other effects can be clearly understood by those skilled in the art from the following description.

### INDUSTRIAL APPLICABILITY

The present disclosure was described through examples that are applied to an autonomous driving system (Automated Vehicle & Highway Systems) on the basis of a 5G (5 generation) system, but the present disclosure may be applied to various wireless communication systems and autonomous driving systems.

What is claimed is:

1. A method of controlling a vehicle that perform platooning in an autonomous driving system (Automated Vehicle & Highway Systems), in which the several vehicles constituting a platoon include a first vehicle controlling platooning and a second vehicle controlled by the first vehicle, and the method includes:
checking information of the platoon by means of the first vehicle;
requesting information about out-platoon vehicles from a server by means of the first vehicle;
receiving the information about the output-platoon vehicles from the server by means of the first vehicle;
determining a passing operation of the platoon on the basis of the platoon information and the information about the out-platoon vehicles by means of the first vehicle;
transmitting information about the passing operation to the second vehicle by means of the first vehicle; and
controlling the several vehicles to pass a target vehicle.

2. The method of claim 1, wherein the information of the platoon includes at least one of the number of vehicles constituting the several vehicles, the shape of the platoon, a destination, a target arrival time, and a predicted arrival time.

3. The method of claim 1, wherein the information about the out-platoon vehicles includes at least one of items of information such as the locations, speeds, and lanes of the out-platoon vehicles.

4. The method of claim 1, wherein the determining of a passing operation further includes securing a preparation lane in preparation for the case in which passing fails.

5. The method of claim 4, wherein the first vehicle transmits no-entering notification to the out-platoon vehicle through a vehicle network based on confirming that an out-platoon vehicle enters the preparation lane.

6. The method of claim 4, wherein some vehicles of the several vehicles fail in passing moves to the preparation lane.

7. The method of claim 1, wherein the shape of the platoon is deformed in accordance with the number of lanes to be used for passing, the speed of the target vehicle, and the gap between the platoon and the target vehicle.

8. The method of claim 7, wherein the entire platoon passes the target vehicle while maintaining the shape of the platoon.

9. The method of claim 1, wherein a passing situation is monitored using at least one device of the first vehicle.

10. The method of claim 1, further comprising broadcasting information about a lane to be used for passing to the out-platoon vehicles by means of the first vehicle.

11. The method of claim 10, further comprising receiving permission to use and available time for the lane to be used for passing from the out-platoon vehicles by means of the first vehicle.

12. The method of claim 1, wherein the first vehicle and the server communicate through V2X.

13. The method of claim 1, further comprising forming a new shape of platoon with vehicles that have succeeded in passing.

14. The method of claim 13, wherein the new shape is formed on the basis of the point in time of departing from the platoon.

15. The method of claim 13, wherein the new shape is formed on the basis of capability of a vehicle.

16. An apparatus for controlling platooning vehicles, wherein several vehicles that pass a target vehicle in an autonomous driving system (Automated Vehicle & Highway Systems) perform platooning by constituting a platoon and includes a first vehicle controlling the platooning and a second vehicle controlled by the first vehicle,
wherein the first vehicle includes:
a communication module;
a memory; and
a processor, and
the processor
checks information about the platoon,
requests information about out-platoon vehicles by controlling the communication module,
receives the information about the out-platoon vehicles from the server by controlling the communication module,
controls the communication module to determine a passing operation of the platoon on the basis of the platoon information and the information about the out-platoon vehicles and to transmit the information about the passing operation to the second vehicle, and
controls vehicles that perform the platooning to pass the target vehicle.

17. The apparatus of claim 16, wherein the first vehicle further includes at least one of a sensor or a camera, and monitors a situation of performing passing using at least one of the sensor or the camera.

18. The apparatus of claim 16, wherein the processor operates to secure a preparation lane in preparation for a case in which passing fails.

19. The apparatus of claim 18, wherein the processor controlls the communication module to transmit no-entry notification to the out-platoon vehicle through the vehicle network based on the confirmation that the vehicles other than the group enter the spare lane.

20. The apparatus of claim 18, wherein a vehicle which fails to pass moves to the preparation lane.

21. The apparatus of claim 16, wherein the information of the platoon includes at least one of the number of vehicles constituting the several vehicles, the shape of the platoon, a destination, a target arrival time, and a predicted arrival time.

22. The apparatus of claim 16, wherein the information about the out-platoon vehicles includes at least one of items of information such as the locations, speeds, and lanes of the out-platoon vehicles.

23. The apparatus of claim 16, wherein the processor controls the communication module to transmit information about a lane to be used for passing to the out-platoon vehicles.

24. The apparatus of claim 16, wherein the processor controls the shape of the platoon to be deformed in accordance with the number of lanes to be used for passing, the speed of the target vehicle, and the gap between the platoon and the target vehicle.

25. The apparatus of claim 24, wherein the passing operation information includes information that instructs the entire platoon to perform passing while maintaining the shape of the platoon.

26. The apparatus of claim 16, wherein the processor forms a new shape of platoon with vehicles that have succeeded in passing.

27. The apparatus of claim 26, wherein the processor controls the communication module to transmit the new shape of platoon to the second vehicle.

28. The apparatus of claim 26, wherein the new shape is formed on the basis of the point in time of departing from the platoon.

29. The apparatus of claim 26, wherein the new shape is formed on the basis of capability of a vehicle.

30. The apparatus of claim 16, wherein the processor controls the communication module to receive a passing result from the second vehicle.
